(19) United States
(12) Patent Application Publication
(10) Pub. No.: US 2005/0044538 A1
(43) Pub. Date: Feb. 24, 2005

(54) Interprocedural computing code optimization method and system

(76) Inventor: Srinivas Mantripragada, Santa Clara, CA (US)

Correspondence Address: CARR & FERRELL LLP, 2200 GENG ROAD, PALO ALTO, CA, 94303, US

(21) Appl. No.: 10/921,004

(22) Filed: Aug. 17, 2004

Related U.S. Application Data
(60) Provisional application No. 60/496,003, filed on Aug. 18, 2003.

(51) Int. Cl. G06F 9/45

(52) U.S. Cl. 717/151

(57) ABSTRACT

A system for optimizing computing code containing procedures identifies code blocks as hot blocks or cold blocks in each procedure based on the local block weights of the code blocks in the procedure. The hot blocks are grouped into an intraprocedure hot section and an intraprocedure cold section for each procedure to optimize the procedure. The intraprocedure hot sections in the procedures are selectively grouped into an interprocedure hot section and the intraprocedure cold sections are selectively grouped into an interprocedure cold section, based on global block weights of the code blocks, to optimize the computing code. Additionally, code sections from called procedures can be duplicated into calling procedures to further optimize the computing code.

### CROSS-REFERENCE TO RELATED APPLICATIONS

The present application claims the benefit of commonly owned U.S. Provisional Patent Application No. 60/496,003, filed on Aug. 18, 2003 and entitled “Interprocedural Computing Code Optimization Method and System”, which is incorporated by reference herein.

### BACKGROUND OF THE INVENTION

1. Field of the Invention

The present invention relates generally to a system and method for optimizing computing code, and more particularly to systems and methods for performing interprocedure transformations to optimize the computing code.

2. Background Art

Modern computing systems execute large volumes of computing code at an ever increasing rate to support a greater number of users than ever imagined in years past. Improving the efficiency of such systems is of growing import. Further, as processor speed has advanced beyond memory speed, the need for optimizing computing code for memory accesses has increased.

Endeavors to optimize computing code have ranged from tailoring code for a better match with a given operating environment to rewriting code for elimination of processing bottlenecks. One of these prior approaches has used an execution profile for the code to perform intraprocedure transformations on the code. The execution profile, obtained by executing the code on an exemplary set of inputs, contains performance characteristics for the code. It is these performance characteristics which are then used to determine which intraprocedure code transformations should be made to optimize the code.

Known computing code optimizations have provided limited benefits. While successful in some settings, such optimizations have not yielded significant performance benefits with more complex computing code containing multiple procedures. A need exists for techniques that optimize computing code containing multiple procedures.

### SUMMARY OF THE INVENTION

The present invention addresses a need for optimizing computing code containing multiple procedures. In the present invention, a code optimizer performs intraprocedure transformations on the computing code by grouping frequently executed code blocks of computing instructions within procedures of the computing code to optimize execution of the code blocks in the procedures. The code optimizer then groups frequently executed code blocks across procedure boundaries (i.e., interprocedurally) to optimize execution of the code blocks across the procedures.

In a method according to the present invention, a local block weight is obtained for each code block in each procedure of a computing code. Each code block in the procedure is then identified as a hot block or a cold block based on the local block weight of the code block. In each procedure, the hot blocks are grouped into an intraprocedure hot section and the cold blocks are grouped into an intraprocedure cold section to optimize the procedure. The hot blocks in the intraprocedure hot sections are selectively grouped into an interprocedure hot section and the cold blocks in the intraprocedure cold sections are selectively grouped into an interprocedure cold section, to optimize the computing code.

In a computer program product according to the present invention, the computer program product includes computing instructions for obtaining a local block weight for each code block in each procedure of a computing code. Additionally, the computer program product includes computing instructions for identifying each code block in a procedure as a hot block or a cold block based on the local block weight of the code block. The computer program product further includes computing instructions for grouping the hot blocks in each procedure into an intraprocedure hot section of the procedure, and grouping the cold blocks in each procedure into an intraprocedure cold section for the procedure. Additionally, the computer program product includes computing instructions for selectively grouping the hot blocks in the intraprocedure hot sections into an interprocedure hot section and selectively grouping the cold blocks in the intraprocedure cold sections into an interprocedure cold section, to optimize the computing code.

A system according to the present invention includes a compiler for obtaining a local block weight for each code block in each procedure of a computing code. The local block weight of a code block in a procedure can be based on a performance characteristic of the code block within the procedure. The compiler identifies each code block in the procedure as a hot block or a cold block based on the local block weight of the code block. The compiler then groups the hot blocks in each procedure into an intraprocedure hot section for the procedure and the cold blocks in each procedure into an intraprocedure cold section for the procedure.

The system also includes a linker for obtaining a global block weight for each code block in the computing code. The global block weight can be based on the local block weights of the code blocks across the computing code. The linker selectively groups and intermixes the hot blocks contained in the intraprocedure hot sections into an interprocedure hot section based on the global block weights of the code blocks. Additionally, the linker selectively groups the cold blocks in the intraprocedure cold sections into an interprocedure cold section based on the global block weights of the code blocks. Grouping and intermixing the code blocks in the computing code optimizes the computing code.

A computing system according to the present invention includes a processor, a memory device, an input-output device, a compiler and a linker. The processor loads the compiler and a computing code from the input-output device into the memory device. The processor then executes the compiler to obtain a local block weight for each code block in each procedure of the computing code. The local block weight can be a performance characteristic of the code block within the procedure. Also, during execution of the compiler, the compiler identifies each code block in each procedure as a hot block or a cold block, based on the local block weight of the code block. Further, during execution of the compiler, the compiler groups the hot blocks in each procedure into an intraprocedure hot section for the procedure and the cold blocks in each procedure into an intraprocedure cold section for the procedure.

The processor loads the linker from the input-output device into the memory device and executes the linker to obtain a global block weight for each code block in the computing code. The global block weight can be based on the local block weights of the code blocks across the computing code. Also, during execution of the linker, the linker selectively group and intermixes the hot blocks contained in the intraprocedure hot sections into an interprocedure hot section and selectively groups the cold blocks contained in the intraprocedure cold sections into an interprocedure cold section, based on the global block weights. Grouping and intermixing the code blocks optimizes the computing code for the computing system.

### BRIEF DESCRIPTION OF THE DRAWINGS

FIG. 1 is a block diagram of a prior art computing system;

FIG. 2 is a block diagram of a code optimizer, in accordance with the present invention;

FIG. 3 is a block diagram of an exemplary procedure in the computing code shown in FIG. 2, in accordance with the present invention;

FIG. 4 is a block diagram of an exemplary control flow graph for the procedure shown in FIG. 3, in accordance with the present invention;

FIG. 5 is a block diagram of an exemplary memory map for the procedure shown in FIG. 3, in accordance with the present invention;

FIG. 6 is a block diagram of an exemplary control flow graph for the procedure shown in FIG. 3, in accordance with the present invention;

FIG. 7 is a block diagram of an exemplary memory map for the procedure shown in FIG. 3, in accordance with the present invention;

FIG. 8 is a block diagram of an exemplary intraprocedure hot section for the procedure shown in FIG. 3, in accordance with the present invention;

FIG. 9 is a block diagram of an exemplary intraprocedure cold section for the procedure shown in FIG. 3, in accordance with the present invention;

FIG. 10 is a block diagram of an exemplary memory map for the procedure shown in FIG. 3 after the code blocks are grouped into an intraprocedure hot section and an intraprocedure cold section, in accordance with the present invention;

FIG. 11 is a block diagram of an exemplary directed call graph for the computing code shown in FIG. 2, in accordance with the present invention;

FIG. 12 is a block diagram of an exemplary directed call graph for the computing code shown in FIG. 2, in accordance with the present invention;

FIG. 13 is a block diagram of a portion of an instruction memory containing code blocks of the computing code shown in FIG. 2 and represented in the directed call graph shown in FIG. 11, in accordance with the present invention;

FIG. 14 is a block diagram of a portion of an instruction memory containing code blocks of the computing code shown in FIG. 2 and represented in the directed call graph shown in FIG. 11, in accordance with the present invention;

FIG. 15 is a block diagram of a portion of an instruction memory containing code blocks of the computing code shown in FIG. 2 and represented in the directed call graph shown in FIG. 11, in accordance with the present invention;

FIG. 16 is a block diagram of an exemplary interprocedure hot section, in accordance with the present invention;

FIG. 17 is a block diagram of an exemplary interprocedure cold section, in accordance with the present invention;

FIG. 18 is a block diagram of an exemplary memory map for the computing code shown in FIG. 3 and represented in the directed call graph shown in FIG. 11, in accordance with the present invention;

FIG. 19 is a flow chart of a method for optimizing the computing code shown in FIG. 2, in accordance with the present invention;

FIG. 20 is a flow chart showing further details of a portion of the method shown in FIG. 19 for obtaining a directed call graph, in accordance with the present invention; and

FIG. 21 is a flow chart showing further details of a portion of the method shown in FIG. 19 for selectively grouping intraprocedure hot sections into an interprocedure hot section and selectively grouping intraprocedure cold sections into an interprocedure cold section, in accordance with the present inventions.

### DETAILED DESCRIPTION OF THE PREFERRED EMBODIMENT

The present invention provides a system and method for optimizing a computing code. The computing code includes multiple procedures, each of which includes one or more computing instructions grouped into one or more code blocks. In one embodiment, the frequently executed code blocks in each procedure are identified as hot blocks and the infrequently executed code blocks in each procedure are identified as cold blocks. The hot blocks within each procedure are grouped into an intraprocedure hot section to optimize execution of the procedure. The cold blocks within each procedure are grouped into an intraprocedure cold section. The hot blocks in the intraprocedure hot sections are selectively grouped and intermixed into an interprocedure hot section to optimize execution of the computing code. The cold blocks in the intraprocedure cold sections are selectively grouped into an interprocedure cold section. In this way, the computing code is optimized by being transformed both intraprocedurally and interprocedurally to group together those code blocks that are most frequently executed. Although grouping and intermixing the code blocks is based on the execution frequencies of the code blocks in this embodiment, grouping and intermixing the code blocks can be based on other performance characteristics of the code blocks to optimize the computing code in the present invention.

The system for optimizing a computing code includes a compiler and a linker. The compiler obtains a control flow graph for each procedure in the computing code. The control flow graph includes a local block weight for each code block in the procedure. The local block weight of a code block is based on a performance characteristic of the code block in the procedure (e.g., execution frequency of the code block in the procedure). The compiler identifies each code block as a hot block or a cold block based on the local block weight of the code block. The hot blocks have a local block weight that is preferred (e.g., frequency of code execution is higher) over that of the cold blocks. The complier identifies the remaining code blocks in the procedure as cold blocks. Additionally, the compiler groups the hot blocks into an intraprocedure hot section to optimize execution of the procedure. Further, the compiler groups the cold blocks into an intraprocedure cold section for the procedure. Grouping the hot blocks for execution within a procedure based on the local block weights of the code blocks is an intraprocedural transformation that optimizes the procedure.

The linker obtains a directed call graph for the computing code, which includes a global block weight for each code block in the computing code. The global block weight is based on the local block weights of the code blocks across the computing code (e.g., execution frequencies of the code blocks in the computing code). The linker selectively groups and intermixes the hot blocks in the intraprocedure hot sections into an interprocedure hot section and groups the cold blocks in the intraprocedure cold sections into an interprocedure cold section, based on the global block weights. Grouping the hot blocks and cold blocks both intraprocedurally and interprocedurally optimizes execution of the computing code.

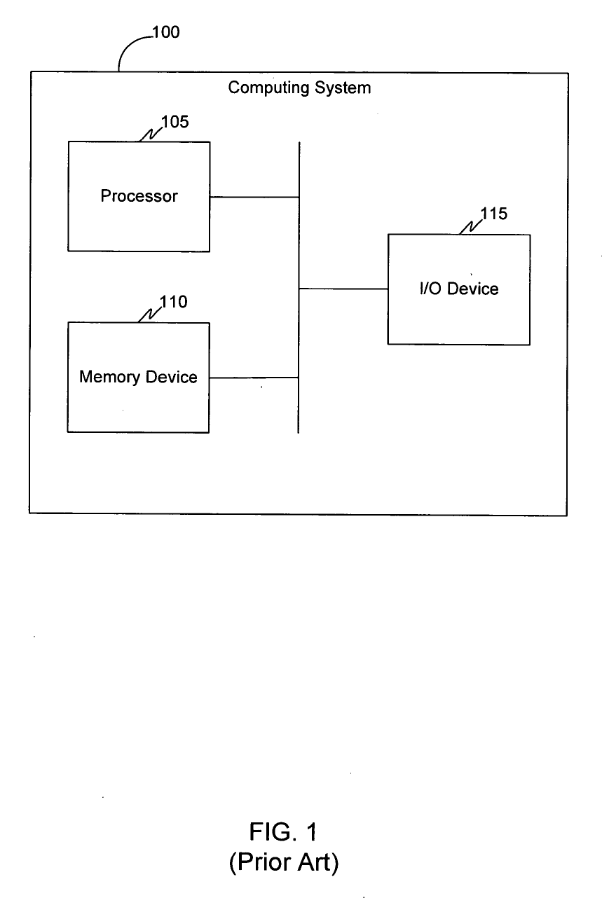

Referring to FIG. 1, a general purpose computing system 100 known in the art is shown. The computing system 100 includes a processor 105, a memory device 110 and an input-output device 115. The processor 105 communicates with the memory device 110 to retrieve data from the memory device 110 and to store data into the memory device 110. Additionally, the processor 105 and the memory device 110 communicate with the input-output device 115 to obtain data from the input-output device 115 and to provide data to the input-output device 115.

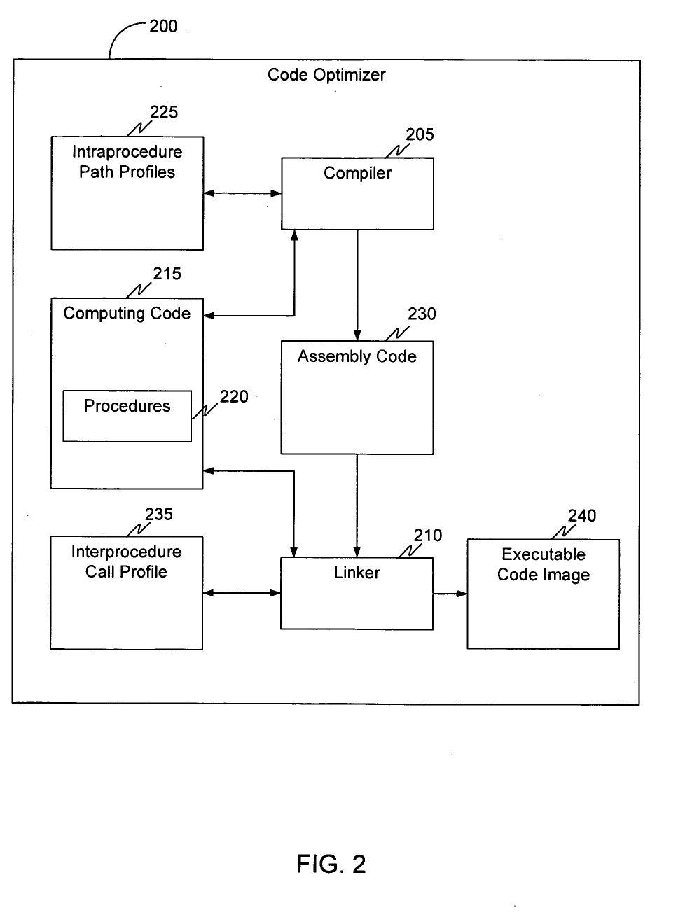

Referring now to FIG. 2, a code optimizer 200 according to the present invention is shown. The code optimizer 200 includes a compiler 205 and a linker 210. The compiler 205 accesses a computing code 215, which includes procedures 220, and instruments the computing code 215 for generating an intraprocedure path profile 225 for each of the procedures 220. The instrumented computing code 215 is then executed (e.g., executed on computing system 100) to generate the intraprocedure path profiles 225. The intraprocedure path profiles 225 contain performance characteristics (e.g., statistical information or performance measurements) for the procedures 220, as is explained more fully herein. It is to be understood that instrumentation of the computing code 215 by the compiler is optional in the present invention, and that the intraprocedure path profiles 225 can be obtained from another source.

The compiler 205 builds a control flow graph for each of the procedures 220 based on the intraprocedure path profile 225 of the procedure 220. The compiler 205 then optimizes each of the procedures 220 based on the control flow graph of the procedure 220, as is explained more fully herein. It is to be understood that building the control flow graphs by the compiler is optional in the present invention, and that the control flow graphs can be obtained from another source.

The compiler 205 generates an assembly code 230 based on the control flow graphs of the procedures 220, as is described more fully herein. The linker 210 optimizes the computing code 215 based on the assembly code 230, as is explained more fully herein. It is to be understood that the generation of the assembly code 230 by the compiler 205 is optional in the present invention, and that the assembly code 230 can be obtained from another source.

The linker 210 instruments the computing code 215 for generating an interprocedure call profile 235. The instrumented computing code 215 is then executed (e.g., executed on computing system 100) to generate the interprocedure call profile 235. The interprocedure call profile 235 contains performance characteristics (e.g., statistical information or performance measurements) for the computing code 215, as is explained more fully herein.

The linker 210 builds a directed call graph for the computing code 215 based on the assembly code 230 and the interprocedure call profile 235, as is explained more fully herein. The linker 210 then optimizes the computing code 215 based on the directed call graph, as is explained more fully herein.

The linker 210 generates an executable code image 240 for the computing code 215 based on the directed call graph. The executable code image 240 is a configuration of the optimized computing code 215 that can be executed on a target computing system (e.g., computing system 100). It is to be understood that generation of the executable code image 240 by the linker is optional in the present invention.

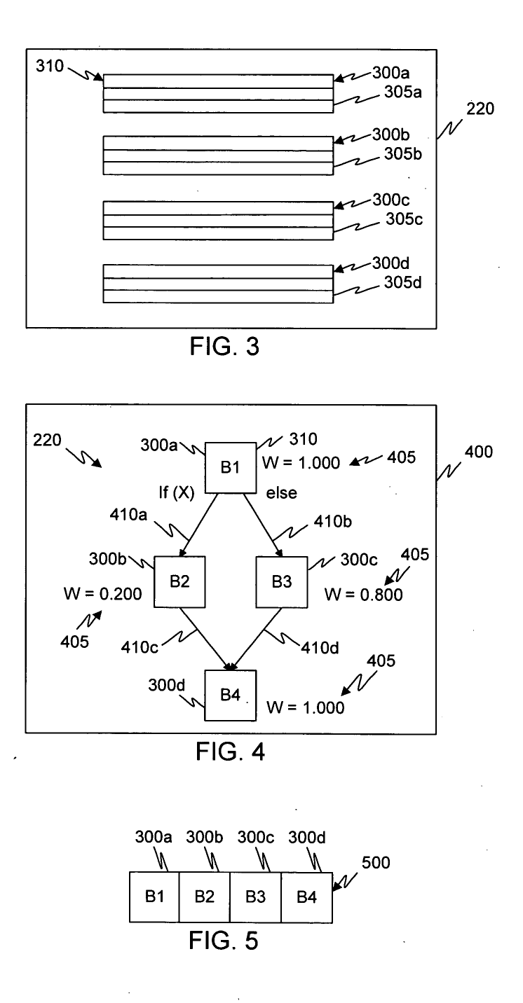

Referring now to FIG. 3, details of an exemplary procedure 220 are shown. The procedure 220 includes one or more code blocks 300, each of which includes one or more computing instructions 305. For example, each code block 300 can include computing instructions 305 that are each executed sequentially (i.e., a linear sequence of computing instructions) for each execution of the code block 300. The code block 300 of a procedure 220 that is executed first when the procedure 220 is executed is a prologue code block 310. The compiler 205 optimizes the code blocks 300 for execution in the procedure 220 based on the control flow graph of the procedure 220, as is described more fully herein. The linker 210 optimizes the code blocks 300 for execution in the computing code 215 based on the directed call graph of the computing code 215, as is described more fully herein.

Referring now to FIG. 4, an exemplary control flow graph 400 for a procedure 220 is shown. The control flow graph 400 represents the code blocks 300 of the procedure 220, and includes a local block weight 405 for each procedure 220, as is described more fully herein. The local block weight 405 is based on a performance characteristic (e.g., execution frequency) of the code block 300. Additionally, the control flow graph 400 can include one or more intraprocedure edges 410, each of which links two code blocks 300 together based on the control flow of the procedure 220. Each intraprocedure edge 410 represents the control flow from one code block 300 to another code block 300 in the procedure 220.

The control flow graph 400 shown in the figure illustrates an example of the control flow of procedure 220 when the last computing instruction 305 in code block 300a is based on an “If-Else” construct. A high-level language representation of the exemplary procedure 220 in shown in Table 1. A pseudo assembly language representation of the procedure 220 represented in control flow graph 400 is shown in Table 2. The intraprocedure edge 410a connects code block 300a to code block 300b and represents the control flow for code block 300a when the condition of the “If-Else” construct is false. If the condition (i.e., X) of the “If-Else” construct is false when the last computing instruction 305 in code block 300a is executed, the control flow progresses from code block 300a to code block 300b. The intraprocedure edge 410b connects code block 300a to code block 300c and represents the control flow for code block 300a when the condition of the “If-Else” construct is true. If the condition of the “If-Else” construct is true when the last computing instruction 305 in code block 300a is executed, the control flow progresses from code block 300a to code block 300c.

TABLE 1
High-level language representation of procedure

```
P1 {
  B1;
  If (X) {B3} else {B2};
  B4;
  }
```

TABLE 2
Pseudo assembly code representation of procedure

| | |
|---|---|
| | B1 |
| | If (X) Branch L1 |
| | B2 |
| | Branch L2 |
| L1: | B3 |
| L2: | B4 |
| | Return |

Referring now to FIG. 5, an exemplary memory map 500 for a procedure 220 is shown. The memory map 500 illustrates an example of how the code blocks 300 of the procedure 220 shown in FIG. 3 can be arranged in a memory device (e.g., memory device 110 of computing system 100) according to the control flow graph 400 shown in FIG. 4. The arrangement of the code blocks 300 in the memory map 500 can determine the execution performance of the code blocks 300. For example, a set of code blocks 300 arranged in the order in which they will be executed will be more efficiently executed than those arranged in an order requiring jumping back and forth within the memory map 500.

For the memory map 500 shown in the figure, code block 300a is placed in the first location of the memory map 500 because code block 300a is the prologue code block 310 of the procedure 220. Code block 300b is placed in the next location of the memory map 500 because it logically flows from the “If-Else” construct when the condition (i.e., X) is false. Code block 300c is placed in the next location of the memory map 500 because it logically flows from the “If-Else” construct when the condition is true. Code block 300d in placed in the memory map 500 last because it because it logically follows code block 300c. It is to be understood that the arrangement of the code blocks 300a-d in memory map 500 is only an example, and that the code blocks 300 can be placed into the memory map 500 in another order in accordance with the present invention.

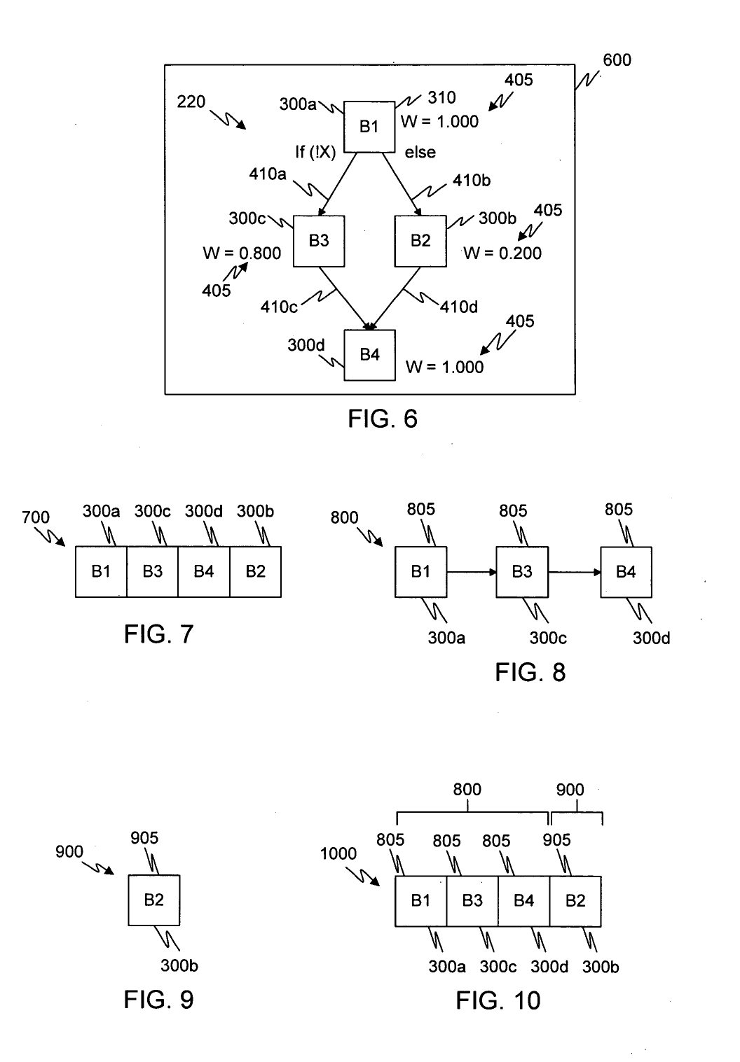

Referring now to FIG. 6, an exemplary control flow graph 600 for a procedure 220 is shown. The control flow graph 600 illustrates an example of the control flow of the procedure 220 shown in FIG. 3 after the compiler 205 has performed an intraprocedure transformation on the procedure 220, as is explained more fully herein. The compiler 205 performs the intraprocedure transformation on the procedure 220 based on the control flow graph 400 of FIG. 4 to optimize execution of the procedure 220 (e.g., optimize execution of the procedure on a computing system 100).

For this example, the local block weight 405 of code block 300c is preferred over the local block weight of code block 300b (e.g., the execution frequency of code block 300c is higher than the execution frequency of code block 300b). The compiler 205 optimizes the procedure 220 for execution based on performance characteristics by modifying the condition of the “If-Else” construct and adjusting the control flow graph 400 of FIG. 4 to form the control flow graph 600 of FIG. 6 so that code block 300c will be placed after code block 300a in a memory map of the procedure 220, as is explained more fully herein.

As shown in the control flow graph 600 of FIG. 6, the “If-Else” construct has a negated condition (i.e., !X) as a result of the intraprocedure transformation. For this example, the intraprocedure edge 410a connects code block 300a to code block 300c and represents the control flow for code block 300a when the negated condition of the “If-Else” construct is false (i.e., the condition is true). If the negated condition of the “If-Else” construct is false when the instruction is executed, the control flow progresses from code block 300a to code block 300c. Additionally, the intraprocedure edge 410b connects code block 300a to code block 300b and represents the control flow of the procedure 220 when the negated condition of the “If-Else” construct is true (i.e., the condition is false). Although the condition of the “If-Else” construct is negated in the last computing instruction 305 of code block 300a and control flow graph 400 of FIG. 4 is adjusted to form the adjusted control flow graph 600 of FIG. 6, the control flow of the procedure 220 represented by the control flow graph 400 is the essentially the same as the control flow of the adjusted control flow graph 600.

Referring now to FIG. 7, an exemplary memory map 700 for a procedure 220 is shown. The memory map 700 illustrates an example of how the code blocks 300 of the procedure 220 shown in FIG. 3 can be arranged in a memory device (e.g., memory device 110 of computing system 100) according to the control flow graph shown in FIG. 6 (i.e., after an intraprocedure transformation). Code block 300a is placed in the first location of the memory map 700 because code block 300a is the prologue code block 310 of the procedure 220. Code block 300c is placed in the next location of the memory map 700 because it logically flows from the “If-Else” construct when the negated condition (i.e., !X) is false. Code block 300d is placed in the next location of the memory map 700 because it logically follows code block 300c. Code block 300b is placed in the memory map 700 last because it logically flows from the “If-Else” construct when the negated condition is true.

In contrast to the memory map 500 shown in FIG. 5, in which code block 300b follows code block 300a, in the memory map shown in FIG. 7, code block 300a follows code block 300a. The arrangement of the code blocks 300 in the memory map 700 is an optimization of the procedure 220 because the code blocks 300a and 300c of the procedure 220 can be executed sequentially and code block 300c has a local block weight 405 that is preferred over that of code block 300b. It is to be understood that the arrangement of the code blocks 300a-d in memory map 700 is only an example, and that the code blocks 300 can be placed into the memory map 700 in another order in accordance with the present invention.

Referring now to FIG. 8, an exemplary intraprocedure hot section 800 (i.e., a hot trace) for a procedure 220 is shown. The compiler 205 identifies one or more code blocks 300 in each procedure 220 as hot blocks 805 based on the local block weights 405 of the code blocks 300 in the procedure 220 and groups the hot blocks 805 into the intraprocedure hot section 800, as is explained more fully herein. The hot blocks 805 generally have a local block weight 405 that is preferred over those of other code blocks 300 in the procedure 220. In the intraprocedure hot section 800 shown in the figure, the compiler 205 has identified code blocks 300a, 300c and 300d as hot blocks 805. Grouping the hot blocks 805 into the intraprocedure hot section 800 (i.e., hot trace) optimizes execution of the hot blocks 805 in the procedure 220.

Referring now to FIG. 9, an exemplary intraprocedure cold section 900 (i.e., cold trace) for a procedure 220 is shown. The compiler 205 identifies one or more code blocks 300 of each procedure 220 as cold blocks 905 based on the local block weights 405 of the code blocks 300 in the procedure 220 and groups the cold blocks 905 into the intraprocedure cold section 900, as is explained more fully herein. The cold blocks 905 generally have a local block weight 405 that is less preferred to those of other code blocks 300 (e.g., hot blocks 805) in the procedure 220. In the intraprocedure cold section 900 shown in the figure, the compiler 205 has identified code block 300b as a cold block 905. Grouping the cold blocks 905 into the intraprocedure cold section 900 (i.e., cold trace) optimizes execution of the hot blocks 805 in the procedure 220. For example, the hot blocks 805 can be arranged in a memory map in the order in which they will be more efficiently executed than those arranged in an order requiring jumping over the cold blocks 905.

In one embodiment, the grouping of the code blocks 300 of a procedure 220 into an intraprocedure hot section 800 (i.e., hot trace) and an interprocedure cold section 900 (i.e., cold trace) is performed before the control flow graph (e.g., control flow graph 400) is adjusted to reflect modified control constructs (e.g., a negated condition in an “If-Else” construct). In another embodiment, grouping of the code blocks 300 of the procedure 220 into an intraprocedure hot section 800 (i.e., hot trace) and an interprocedure cold section 900 (i.e., cold trace) is performed after the control flow graph is adjusted to reflect modified control constructs. In still another embodiment, grouping of the code blocks 300 of the procedure 220 into an intraprocedure hot section 800 (i.e., hot trace) and an interprocedure cold section 900 (i.e., cold trace) and adjusting the control flow graph to reflect modified control constructs is performed as part of the same process.

A pseudo assembly language representation of the procedure 220 after the grouping of the code blocks 300 into the intraprocedure hot section 800 (i.e., hot trace) and the intraprocedure cold section 900 (i.e., cold trace) in shown in Table 3.

TABLE 3
Pseudo assembly code representation of procedure after
modification of control constructs and grouping of code
blocks into an intraprocedure hot section and an
intraprocedure cold section

| | |
|---|---|
| | B1 |
| | If (!X) Branch L1 |
| | B3 |
| L2: | B4 |
| | Return |
| L1: | B2 |
| | Branch L2 |

Referring now to FIG. 10, an exemplary memory map 1000 for a procedure 220 is shown. The memory map 1000 illustrates an example of how the code blocks 300 of the procedure 220 shown in FIG. 3 can be arranged in a memory device (e.g., memory device 110 of computing system 100) according to the control flow graph 600 shown in FIG. 6, the intraprocedure hot section 800 (i.e., hot trace) shown in FIG. 8, and the intraprocedure cold section 900 (i.e., cold trace) shown in the FIG. 9, as is explained more fully herein.

For the example illustrated in FIG. 10, code blocks 300a, 300c and 300d are hot blocks 805 in the intraprocedure hot section 800 (i.e., hot trace) of the procedure 220, and code block 300b is a cold block 905 in the intraprocedure cold section 900 (i.e., cold trace) of the procedure 220. Code block 300a is placed in the first location of the memory map 1000 because code block 300a is the prologue code block 310 of the procedure 220. Code block 300c is placed in the next location of the memory map 1000 because code block 300c follows code block 300a in a control flow path of the procedure 220 and because code block 300c is in the intraprocedure hot section 800 of the procedure 220. Code block 300d is placed in the next location of the memory map 1000 because code block 300d follows code block 300c in a control flow path of the procedure 220 and code block 300d is in the intraprocedure hot section 800 of the procedure 220. Code block 300b in placed in the memory map 1000 last because it is in the intraprocedure cold section 900 of the procedure 220.

The arrangement of the code blocks 300 in the memory map 1000 is an optimization of the procedure 220 because the code blocks 300a, 300c and 300d are in the intraprocedure hot section 800 (i.e., hot trace) of the procedure 220 and can be executed sequentially according to the memory map 1000. It is to be understood that the arrangement of the code blocks 300a-d in memory map 1000 is only an example, and that the code blocks 300 can be placed into the memory map 1000 in another order in accordance with the present invention.

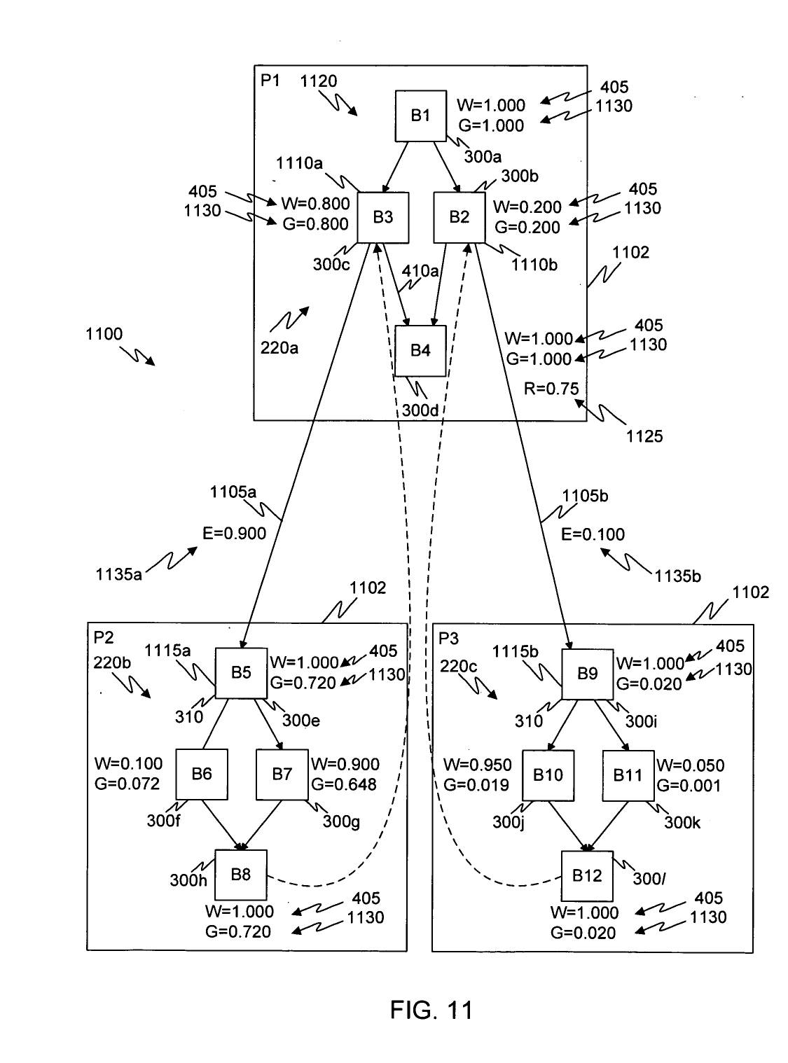

Referring now to FIG. 11, an exemplary directed call graph 1100 for the computing code 215 is shown. The directed call graph 1100 represents the procedures 220 in the computing code 215 and the control flow of the computing code 215. The linker 210 optimizes the code blocks 300 across the procedures 220 based on the directed call graph 1100 to optimize the computing code 215, as is described more fully herein.

The directed call graph 1100 includes a control flow graph 1102 for each of the procedures 220 in the computing code 215. In one embodiment, the linker 210 builds the control flow graphs 1102 based on the assembly code 230, as is explained more fully herein. Additionally, the directed call graph 1100 includes one or more interprocedure edges 1105, each of which links a caller node 1110 in one procedure 220 to a callee node 1115 in another procedure 220. A caller node 1110 is a code block 300 in a procedure 220 (i.e., predecessor procedure) that calls one or more other procedures 220 (i.e., successor procedures). A callee node 1115 is the prologue code block 310 of a successor procedure 220.

Each procedure 220 represented in the directed call graph 1100 that does not have a predecessor procedure 220 is a root procedure 1120 (i.e., a procedure 220 that can be executed without being called by another procedure 220). Each root procedure 1120 represented in the directed call graph 1100 has a root procedure weight 1125, as is described more fully herein. The root procedure weight 1125 is based on a performance characteristic of the root procedure 1120 in the interprocedure call profile 235. Additionally, each code block 300 represented in the directed call graph 1100 has a global block weight 1130, as is explained more fully herein. The global block weight 1130 is based on the local block weights 405 in the directed call graph 1100. Further, each interprocedure edge 1105 in the directed call graph 1100 has an interprocedure edge weight 1135, as is explained more fully herein. The interprocedure edge weight 1135 is based on one or more performance characteristics in the interprocedure call profile 235. For example, the interprocedure edge weight 1135 can be based on the performance characteristics of the caller node 1100 linked to the interprocedure edge 1105 in the directed call graph 1100.

The directed call graph 1100 shown in the figure illustrates a caller node 1110 of a procedure 220 that is linked to a callee node 1115 of another procedure 220 (i.e., a successor procedure) and to a successor code block 300 in the procedure 220 (i.e., a code block 300 that follows the code block 300 in the control flow of the procedure 220). As shown in the figure, caller node 1110a in procedure 220a is linked to callee node 1115a in procedure 220b with interprocedure edge 1105a. Additionally, caller node 1110a of procedure 220a is linked to successor code block 300d of procedure 220a with intraprocedure edge 410a. In this example, the global block weight 1130 of code block 300e is computed by multiplying the global block weight 1130 of code block 300c times the interprocedure edge weight 1135a of interprocedure edge 1105a times the local block weight 405 of code block 300e (e.g., 0.800×0.900×1.000=0.720).

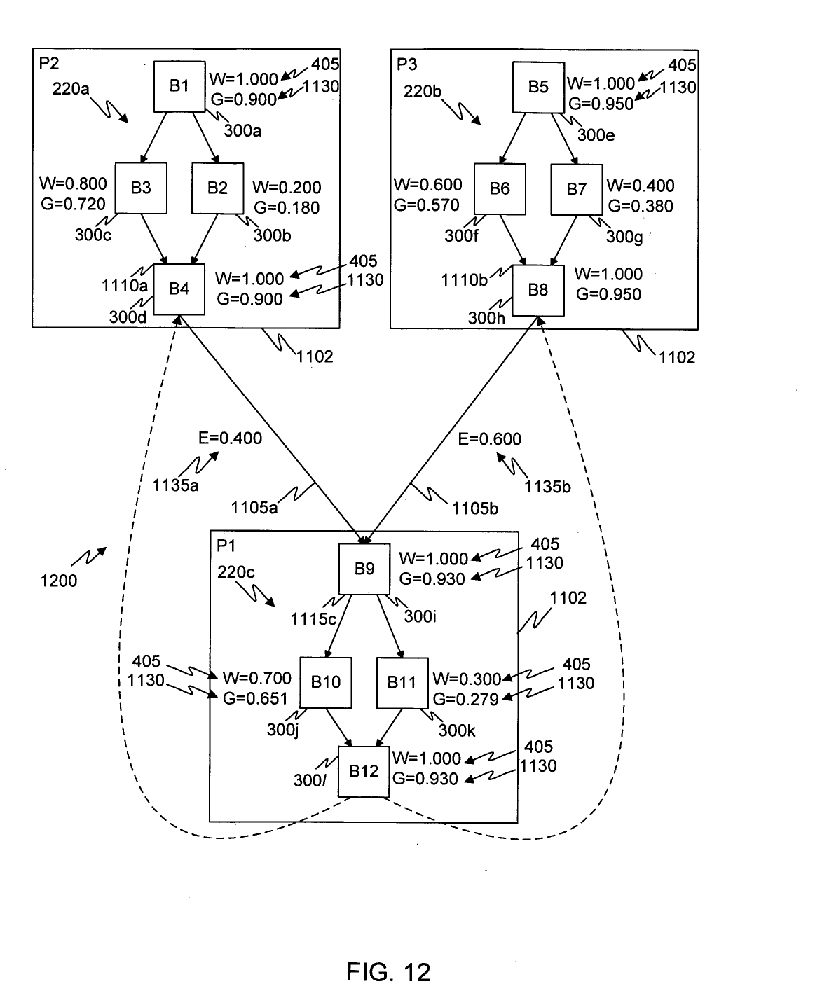

Referring now to FIG. 12, another exemplary directed call graph 1200 is shown. The directed call graph shown in the figure illustrates a callee node 1115 of a procedure 220 that is linked to two caller nodes 1110 of other procedures 220. Caller node 110a of procedure 220a is linked to callee node 1115c of procedure 220c through interprocedure edge 1105a. Caller node 1110b of procedure 220b is linked to callee node 1115c of procedure 220c through interprocedure edge 1105b.

In this example, the global block weight 1130 of code block 300i is computed by first computing an intermediary global block weight for each of the caller nodes 1110a and 1110b. The intermediary global block weight for caller node 1110a is computed by multiplying the global block weight 1130 of caller node 1110a times the interprocedure edge weight 1135 of interprocedure edge 1105b times the local block weight 405 of callee node 1115c (e.g., 0.900×0.400×1.000=0.360). The intermediary global block weight for caller node 1110b is computed by multiplying the global block weight 1130 of caller node 1110b times the interprocedure edge weight 1135b of interprocedure edge 1105b times the local block weight 405 of callee node 1115c (e.g., 0.950×0.600×1.000=0.570). The intermediary global block weights are then summed to compute the global block weight 1130 of callee node 1115c (e.g., 0.360+0.570=0.930).

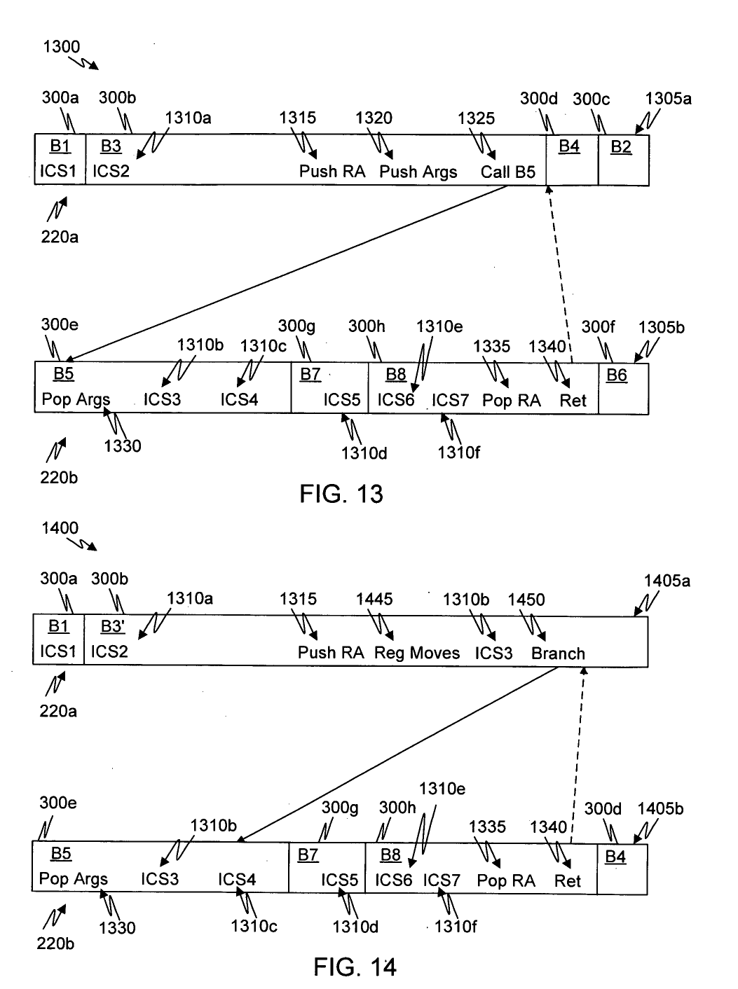

Referring now to FIG. 13, a portion of an instruction memory 1300 is shown. The instruction memory 1300 includes instruction memory lines 1305 that can store code blocks 300 of the computing code 215. For example, the instruction memory 1300 can be a cache memory and the memory lines 1305 can be cache lines of the cache memory.

The instruction memory 1300 shown in the figure illustrates an example of how code blocks 300 in the procedures 220 represented in the directed call graph 1100 shown in FIG. 11 can be stored in the instruction memory 1300. Code block 300a is the first code block 300 in instruction memory line 1305a. Code block 300b follows code block 300a in the instruction memory line 1305a, and code block 300d follows code block 300b in the instruction memory line 1305a. Code block 300c follows code block 300d and is the last code block 300 in instruction memory line 1305a. Code block 300e is the first code block 300 in instruction memory line 1305b. Code block 300g follows code block 300e in instruction memory line 1305b, and code block 300h follows code block 300g in instruction memory line 1305b. Code block 300f follows code block 300h and is the last code block 300 in instruction memory line 1305b.

Code block 300b of procedure 220a includes an instruction code segment 1310a, an address store code segment 1315, an argument store code segment 1320 and a call code segment 1325. The instruction code segment 1310a includes one or more computing instructions 305 in code block 300b. The size of an instruction code segment 1310 can be selected by the compiler 205 during an interprocedure transformation, as is described more fully herein. The call code segment 1325 includes one or more computing instructions 305 for calling procedure 220b. The address store code segment 1315 includes one or more computing instructions 305 for storing a return address (e.g., pushing the return address on a stack memory) of procedure 220a so that procedure 220b can return control flow to procedure 220a after the call from procedure 220a to procedure 220b is complete. The argument store code segment 1320 includes instructions for storing arguments (e.g., pushing the arguments on a stack memory) for a procedure call to procedure 220b so that procedure 220b can retrieve the arguments (e.g., pop the arguments from a stack memory into registers) after the call from procedure 220a to procedure 220b is initiated.

Code block 300e includes an argument restore code segment 1330. The argument restore code segment 1330 includes one or more computing instructions 305 for retrieving arguments (e.g., popping the arguments from a stack memory) stored by another procedure 220 (e.g., procedure 220a). Additionally, the argument restore code segment 1330 can include one or more computing instructions 305 for storing the arguments into a local memory (e.g., registers) for procedure 220b. The code block 300e also includes instruction code segments 1310b and 1310c. The instruction code segments 1310b and 1310c include computing instructions 305 in code block 300e.

Code block 300g includes an instruction code segment 1310d. Code block 300h includes an instruction code segment 1310e and an instruction code segment 1310f that follows instruction code segment 1310e. Additionally, code block 300h includes an address restore code segment 1335 that follows instruction code segment 1310f. The address restore code segment 1335 includes one or more computing instructions 305 for retrieving a return address (e.g., popping the return address from the stack memory) stored by another procedure 220 (e.g., procedure 220a). Further, code block 300h includes a return code segment 1340 that follows the address restore code segment 1335. The return code segment 1340 includes one or more computing instructions 305 for returning execution of the computing code 215 to the return address (e.g., code block 300b) retrieved by the address restore code segment 1335.

Referring now to FIG. 14, a portion of an instruction memory 1400 is shown. The instruction memory 1400 includes instruction memory lines 1405 that can store code blocks 300 of the computing code 215. The instruction memory 1400 shown in the figure illustrates an example of how code blocks 300 in the procedures 220 represented in the directed call graph 1100 shown in FIG. 11 can be stored in the instruction memory 1400.

The example illustrated in the figure illustrates how the procedure 220a represented in the directed call graph 1100 of FIG. 11 can be stored in the instruction memory 1400 after an interprocedure transformation has been performed on the code block 300b of procedure 220a. The interprocedure transformation performed on code block 300b optimizes the computing code 215 for execution from the instruction memory 1400, as is explained more fully herein. For example, the instruction memory 1400 can be a cache memory, and the interprocedure transformation performed on the code block 300b can reduce the number of cache line fetches to the cache memory during execution of the hot blocks 805 in the computing code 215 (e.g., execution of the computing code 215 on the computing system 100). Additionally, the interprocedure transformation performed on the code block 300b can reduce the memory access time to code blocks 300 that are stored in the cache memory during execution of the computing code 215. For example, one or more instruction code segments 1310 in procedure 220b can be replicated into procedure 220a and executed in procedure 220a from instruction memory line 1405a while the code blocks 300 in procedure 220b are prefetched into the instruction memory line 1405b for subsequent execution.

In the interprocedure transformation of code block 300b, an argument store code segment 1320 of FIG. 13 has been replaced with a register move code segment 1445, and a call code segment 1325 of FIG. 13 has been replaced with a branch code segment 1450. Additionally, the instruction code segment 1310b of code block 300e has been replicated and inserted between the register move code segment 1445 and the branch code segment 1450 of code block 300b, as is explained more fully herein.

The branch code segment 1450 includes one or more computing instructions 305 for branching to the instruction code segment 1310c that follows the instruction code segment 1310b in code block 300e of procedure 220b. The register move code segment 1445 includes computing instructions 305 for storing arguments into a local memory (e.g., registers) for procedure 220b before the branch code segment 1450 is executed. The instruction code segment 1310b that is replicated into code block 300b is selected so that the branch code segment 1450 is located near the end of instruction memory line 1405a, as is explained more fully herein.

The execution of the register move code segment 1445 in code block 300b during execution of the computing code 215 avoids storing arguments for a procedure call (e.g., pushing the arguments on a stack memory). The execution of the branch code segment 1450 during execution of the computing code 215 causes the control flow of the procedure 220a to branch over the argument restore segment 1330 of code block 300e and avoids retrieving arguments for the procedure call (e.g., popping the arguments from a stack memory). Additionally, execution of the branch code segment 1450 during execution of the computing code 215 causes the control flow of the procedure 220a to branch over one or more instruction code segments 1310 (e.g., instruction code segment 1310b) that follow the argument restore code segment 1330 in code block 300e. Further, the execution of the branch code segment 1450 during execution of the computing code 215 can cause the control flow of the procedure 220a to branch over other instruction code segments 1310 of successor code blocks of code block 300e, as is explained more fully herein.

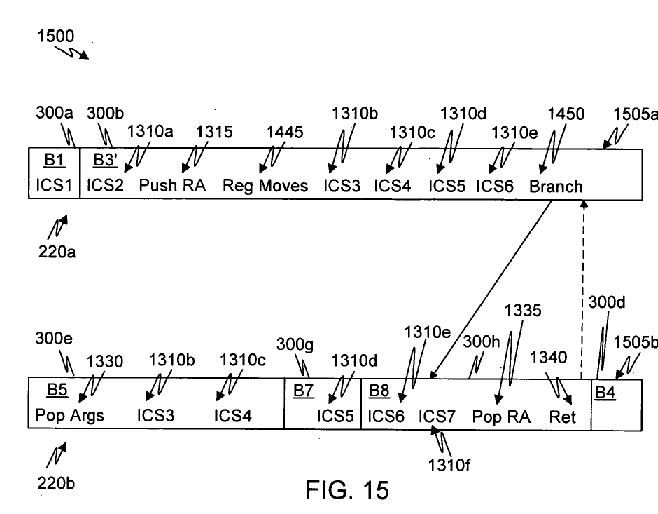

Referring now to FIG. 15, a portion of an instruction memory 1500 is shown. The instruction memory 1500 includes instruction memory lines 1505 that can store code blocks 300 of the computing code 215. The instruction memory 1500 shown in the figure illustrates an example of how code blocks 300 in the procedures 220 represented in the directed call graph 1100 shown in FIG. 11 can be stored in the instruction memory 1500. As shown in the figure, the instruction code segments 1310b and 1310c of code block 300e have been replicated and inserted between the register move code segment 1445 and the branch code segment 1450 of code block 300b in instruction memory line 1505a. Additionally, the instruction code segment 1310d of code block 300g and the instruction code segment 1310e of code block 300h have been replicated and inserted between the replicated code segment 1310c and the branch code segment 1450 of code block 300b in instruction memory line 1505a. The size of the instruction code segment 1310e that is replicated and inserted into code block 300b is selected so that the branch code segment 1450 is located near the end of cache line 1505a, as is explained more fully herein. It is to be understood that the number of instruction code segments 1310 that can be inserted into code block 300b is not limited to the examples described herein. It is to be further understood that the number of instruction code segments 1310 is not limited to any particular number in the present invention.

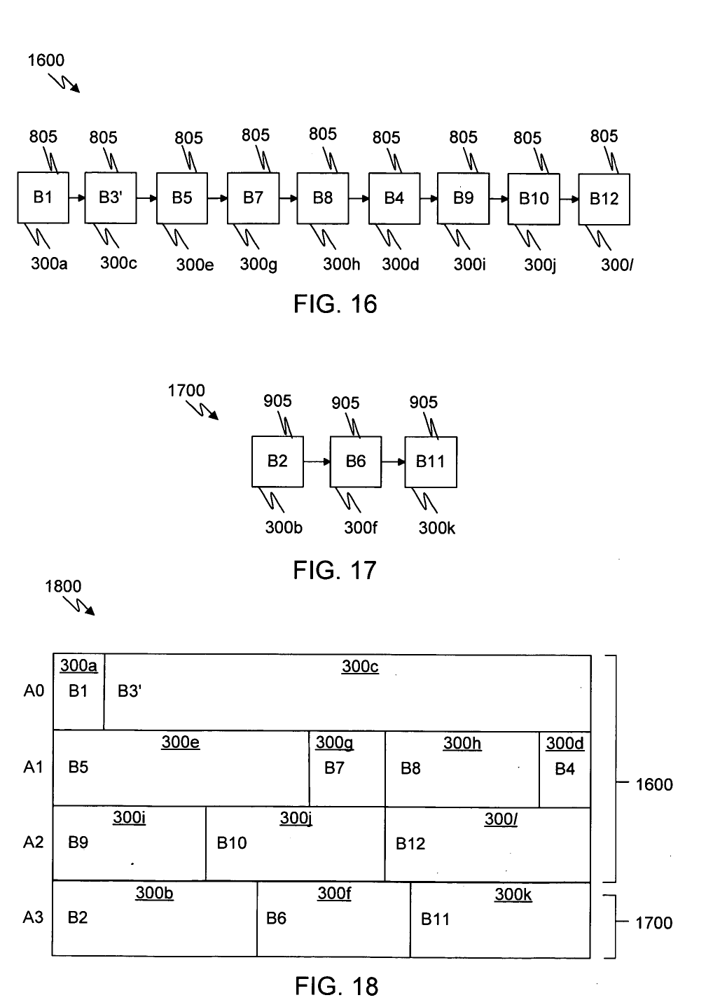

Referring now to FIG. 16, an exemplary interprocedure hot section 1600 is shown. The linker 210 selectively groups the hot blocks 805 of the computing code 215 into an interprocedure hot section 1600 based on the global block weights 1130 of the code blocks 300 in the directed call graph of the computing code 215 (e.g., directed call graph 1100 or 1200), as is explained more fully herein. For example, the linker 210 can selectively group the hot blocks 805 in the intraprocedure hot sections 800 into the interprocedure hot section 1600 based on the global block weights 1130 of the hot blocks 805. The hot blocks 805 in the interprocedure hot section 1600 generally have a global block weight 1130 that is preferred to those of other code blocks 300 in the computing code 215.

Referring now to FIG. 17, an exemplary interprocedure cold section 1700 is shown. The linker 210 selectively groups the cold blocks 905 of the computing code 215 into an interprocedure cold section 1700 based on the global block weights 1130 of the cold blocks 905 in the directed call graph of the computing code 215 (e.g., directed call graph 1100 or 1200), as is explained more fully herein. The cold blocks 905 in the interprocedure cold section 1700 generally have a global block weight 1130 that is less preferred over those of other code blocks 300 in the computing code 215.

Referring now to FIG. 18, an exemplary memory map 1800 for the computing code 215 is shown. The memory map 1800 illustrates an example of how the code blocks 300 of the procedure 220 represented in the directed call graph 1100 shown in FIG. 11 can be arranged in a memory device (e.g., memory device 110 of computing system 100) according to the interprocedure hot section 1600 shown in FIG. 16 and the interprocedure cold section 1700 shown in FIG. 17.

In this example, the linker 210 has placed the hot blocks 805 in the interprocedure hot section 1600 into the memory map 1800 in the same order that the hot blocks 805 are arranged in the interprocedure hot section 1600. Additionally, the linker 210 has placed the cold blocks 905 in the interprocedure cold section 1700 into the memory map 1800 in the same order that the cold blocks 905 are arranged in the interprocedure cold section 1700. For this example, the linker 210 has placed the hot blocks 805 before the cold blocks 905 in the memory map 1800. Additionally, the hot blocks 805 of the computing code 215 are intermixed in the memory map 1800, as is discussed more fully herein. Grouping and intermixing the hot blocks 805 in the memory map 1800 and grouping the cold blocks 905 in the memory map 1800 optimizes execution of the hot blocks 805 in the computing code 215. For example, the hot blocks 805 can be stored in a memory device according to the memory map 1800 and can be sequentially accessed from the memory device during sequential execution of the hot blocks 805. In this example, the sequential access of the hot blocks 805 from the memory device can decrease the access time to the hot blocks 805 and, in turn, decrease the execution time of the hot blocks 805.

The linker 210 generates an executable code image 240 for the computing code 215. In one embodiment, the linker 210 generates the executable code image 240 as the linker 210 places the code blocks 300 into the memory map 1800. In another embodiment, the linker 210 generates the executable code image 240 from the memory map 1800. In one configuration in this embodiment, the linker 210 places the executable code image 240 into the memory map 1800. In another configuration in this embodiment, the linker 210 places the executable code image 240 in a memory device (e.g., memory device 110 of computing system 100). It is to be understood that the generation of the executable code image 240 by the linker 210 is optional in the present invention.

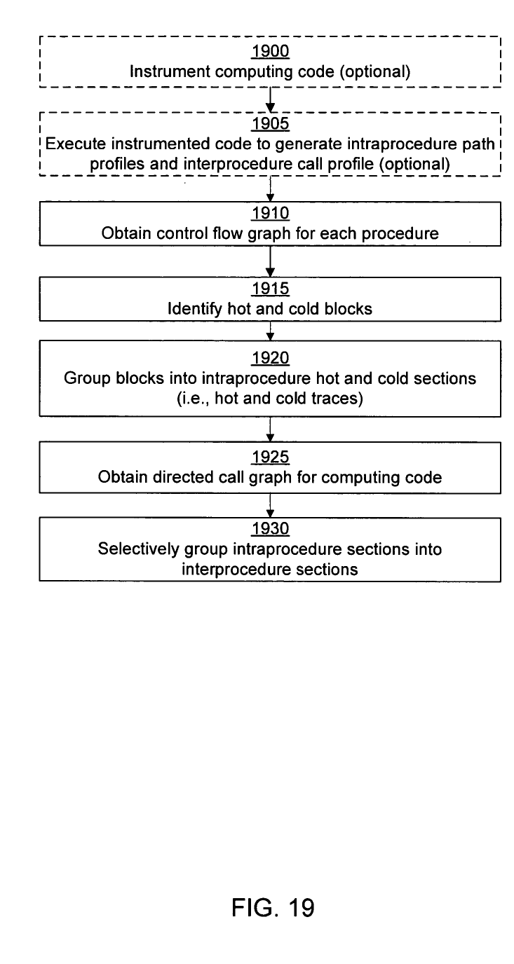

Referring now to FIG. 19, a method for optimizing the computing code 215 is shown. In step 1900, the compiler 205 instruments the computing code 215 for generating the intraprocedure path profile 225 for each procedure 220 in the computing code 215. In the instrumentation process, the compiler 205 inserts computing instructions 305 into the procedure 220 that will generate performance characteristics (e.g., statistical information or performance measurements) for the procedure 220 when the instrumented computing code 215 is executed. For example, the processor 105 of the computing system 100 can load the compiler 205 and the computing code 215 from the input-output device 115 into the memory device 110. The processor 105 can then access the compiler 205 and the computing code 215 in the memory device 110 and execute the compiler 205 on the computing code 215 to generate the instrumented computing code 215 in the memory device 110. It is to be understood that the process of instrumenting the computing code 215 for generating the intraprocedure path profiles 225 is optional in the present invention, and that the intraprocedure path profiles 225 can be obtained from another source.

Also in step 1900, the linker 210 instruments the computing code 215 for generating the interprocedure call profile 235. In the instrumentation process, the linker 210 inserts computing instructions 305 into the computing code 215 to generate performance characteristics (e.g., statistical information or performance measurements) for the root procedures 1120 and interprocedure edges 1105 in the computing code 215. For example, the processor 105 of the computing system 100 can load the linker 210 from the input-output device 115 into the memory device 110. The processor 105 can then access the linker 210 and the computing code 215 in the memory device 110 and execute the linker 210 to instrument the computing code 215 in the memory device 110. It is to be understood that the process of instrumenting the computing code 215 for generating the interprocedure call profile 235 is optional in the present invention, and that the interprocedure call profile 235 can be obtained from another source.

In step 1905, the instrumented computing code 215 is executed to generate the intraprocedure path profiles 225 and the interprocedure call profile 235. For example, the processor 105 of the computing system 100 can load a set of inputs from the input-output device 115 into the memory device 110. The processor 105 can then access the instrumented computing code 215 in the memory device 110 and can execute the instrumented computing code 215 on the set of inputs to generate the intraprocedure path profiles 225 and the interprocedure call profile 235 in the memory device 110. It is to be understood that the execution of the instrumented computing code 215 is optional in the present invention, and that the intraprocedure path profiles 225 and the interprocedure call profile 235 can be obtained from another source.

The performance characteristics (e.g., statistical information or performance measurements) in an intraprocedure path profile 225 of a procedure 220 can include the number of times each of the code blocks 300 in a procedure 220 executes (i.e., execution frequency) when the computing code 215 is executed on a set of inputs. The local block weight 405 for the code block 300 can then be determined based on the performance characteristic of the code block 300. For example, the linker 210 can set the local block weight 405 of a code block 300 to the execution frequency of the code block 300. Additionally, the performance characteristics in the intraprocedure path profile 225 can include an instruction count of the number of computing instructions 305 in each code block 300 in the procedure 220. The linker 210 can compute the execution performance of the procedure 220 based on the instruction counts of the code blocks 300 in the procedure 220, as is described more fully herein.

The performance characteristics (e.g., statistical information or performance measurements) in the interprocedure call profile 235 can include the amount of time spent executing each of the root procedures 1120 (e.g., execution time) and the amount of time spent executing the computing code 215 during execution of the computing code 215 on a set of inputs. The root procedure weight 1125 of the root procedure 1120 can be determined based on the execution time of the root procedure 1120. For example, the linker 210 can compute the root procedure weight 1125 of a root procedure 1120 by dividing the execution time of the root procedure 1120 by the execution time of the computing code 215.

The performance characteristics (e.g., statistical information or performance measurements) in the interprocedure call profile 235 can include the amount of time executing each procedure 220 (e.g., execution time) during execution of the computing code 215. The interprocedure edge weight 1135 for an interprocedure edge 1105 connected between a caller node 1110 and a callee node 1115 can be determined based on the execution time of the procedure 220 containing the caller node 1110. For example, the linker 210 can divide the execution time of the procedure 220 containing the caller node 1110 by the sum of the execution times of all procedures 220 that make a procedure call to the procedure 220 containing the called procedure 220.

In step 1910, a control flow graph (e.g., control flow graph 400) is obtained for each procedure 220 in the computing code 215. For example, the compiler 205 can build a control flow graph for each of the procedure 220, as is discussed more fully herein. The control flow graph (e.g., control flow graph 400) for the procedure 220 includes a representation of the code blocks 300 in the procedure 220. Additionally, the control flow graph includes intraprocedure edges 410 that represent the control flow between the code blocks 300 in the procedure 220. Further, the control flow graph includes the local block weights 405 for the code blocks 300 in the procedure 220 and can include instruction counts for the code blocks 300 in the procedure 220.

In one embodiment of the code optimizer 200, the compiler 205 builds a control flow graph (e.g., control flow graph 400) for each of the procedures 220 based on the intraprocedure path profile 225 of the procedure 220. As part of this process, the processor 105 of the computing system 100 accesses the instrumented computing code 215 and the intraprocedure path profiles 225 in the memory device 110 and executes the compiler 205 to build the control flow graphs in the memory device 110. It is to be understood that the generation of the control flow graphs by the compiler 205 is optional in the present invention, and that the control flow graphs can be obtained from another source.

Also in step 1910, the compiler 205 can modify the control constructs in the procedure 220 to optimize the code blocks 300 for execution in the procedure 220, as is described more fully herein. Additionally, the compiler 205 can adjust the control flow graph (e.g., control flow graph 400) of the procedure 220 to maintain the control flow of the procedure 220, as is described more fully herein.

A high-level language representation of the procedure 220 represented by the control flow graph 400 of FIG. 4 is shown in Table 1. The procedure 220 shown in Table 1 includes an “If-Else” control construct with a condition “X”. A pseudo assembly code representation of the procedure 220 represented by the control flow graph 600 of FIG. 6 is shown in Table 2. The pseudo assembly code representation of the procedure 220 shown in Table 3 is the pseudo assembly code representation of the procedure 220 shown in Table 1 after an intraprocedure transformation of the procedure 220.

In step 1915, the compiler 205 identifies the hot blocks 805 and cold blocks 905 in each of the procedures 220 of the computing code 215, based on the local block weights 405 of the code blocks 300 in the procedure 220. In one embodiment, the compiler 205 builds a working set of code blocks 300 for each procedure 220, which contains the code blocks 300 in the procedure 220. The compiler 205 then identifies the code blocks 300 in the working set that are below a threshold value (e.g., predetermined execution frequency of the code blocks) as cold blocks 905. The compiler 205 removes the cold blocks 905 from the working set and identifies the remaining code blocks 300 in the working set as hot blocks 805.

In step 1920, the compiler 205 groups the hot blocks 805 in each procedure 220 into an intraprocedure hot section 800 (i.e., hot trace) and the cold blocks 805 in the procedure 220 into an intraprocedure cold section 900 (i.e., cold trace), based on the local block weights 405 of the code blocks 300. Grouping the hot blocks 805 into the intraprocedure hot section 805 and the cold blocks 905 into the intraprocedure cold section 900 optimizes the hot blocks 805 for execution in the procedure 220.

In one embodiment, the compiler 205 builds a working set of code blocks 300 that are hot blocks 805. The compiler 205 then searches for a seed block in the working set. A seed block is a hot block 805 in a procedure 220 that has a successor hot block 805 in the control flow graph (e.g., control flow graph 600) of the procedure 220, which itself is in the working set. If the compiler 205 finds a hot block 805 in the working set that is a seed block, the compiler adds the hot block 805 to the intraprocedure hot section 800 and removes the hot block 805 from the working set. The compiler 205 then selects the successor hot block 805 from the working set and processes this selected hot block 805 in essentially the same manner as described herein. This process is repeated until the selected hot block 805 does not have a successor hot block 805 in the control flow graph (e.g., control flow graph 400) of the procedure 220 that is in the working set. For this hot block 805, the compiler 205 adds the hot block 805 to the intraprocedure hot section 800 and removes the hot block 805 from the working set. The compiler 205 then selects the next hot block 805 in the working set that is a seed block and processes this selected hot block 805 in essentially the same manner as described herein.

If the compiler 205 does not find a hot block 805 that is a seed block in the working set, the compiler 205 selects the next hot block 805 in the working set. The compiler 205 adds the selected hot block 805 to the intraprocedure hot section 800 and removes the selected hot block 805 from the working set. This process is then repeated for the remaining hot blocks 805 in the working set.

In one embodiment, the compiler 205 builds a working set of code blocks 300 that are colds blocks 905. The compiler 205 then adds the cold blocks 905 to the intraprocedure cold section 900 in essentially the same manner as described herein for adding the hot blocks 805 to the intraprocedure hot section 800.

In one embodiment, the compiler 205 generates an assembly code 230 for the computing code 215. The assembly code 230 includes a representation of the intraprocedure hot sections 800 and intraprocedure cold sections 900 for the procedures 220 in the computing code 215. Additionally, the assembly code 230 includes a hot directive that identifies the intraprocedure hot section 800 for each procedure 220 and a cold directive that identifies the intraprocedure cold section 900 for each procedure 220. The assembly code 230 also includes a directive for each intraprocedure edge 410 in the procedure 220. The directives for the intraprocedure edges 410 include connectivity information for the intraprocedure edges 410 (e.g., how the intraprocedure edge 410 is connected to code blocks 300 in the control flow graph of the procedure). Additionally, the assembly code 230 can include directives that identify the local block weights 405 of the code blocks 300. Further, the assembly code 230 can include directives for the instruction counts that identify the instructions counts of the code blocks 300.

A pseudo assembly code representation of the procedure 220 shown in FIG. 6 is shown in Table 4. The pseudo assembly code representation of the procedure 220 shown in Table 4 is the pseudo assembly code representation of the procedure 220 shown in Table 3 after the linker 205 has added directives to the assembly code 230 for the procedure 220.

TABLE 4
Pseudo assembly code representation of procedure including directives

#pragma .hot_section_begin

| | |
|---|---|
| # | B1; B1->B2= 0.20; B1->B3= 0.80; InstrCount=7; Weight=1.00; |
| | B1 |
| | If (!X) Branch L1 |
| # | B3; B3->B4= 1.00; InstrCount=12; Weight=0.80; |
| | Branch L3 |
| L1: | B3 |
| # | B4; Instr=9; Weight=1.00; |
| L2: | B4 |
| | Return |

#pragma .hot_section_end
#pragma .cold_section_begin

| | |
|---|---|
| # | B2; B2->B4=1.00; InstrCount=5; Weight=0.20; |
| L3: | B2 |
| | Branch L2 |

#pragma .cold_section_end

In one embodiment, the compiler 205 adjusts the control flow graph (e.g., control flow graph 400) of the procedure 220 so that the hot blocks 805 in the hot section 800 will be placed adjacent to each other in the assembly code 230, and the cold blocks 905 in the cold section 900 will be placed adjacent to each other in the assembly code 230. Additionally, in this embodiment, the compiler 205 places the intraprocedure hot section 800 before the intraprocedure cold section 900 in the assembly code 230. Further, in this embodiment, the processor 105 of the computing system 100 can access the compiler 205 and the control flow graphs (e.g., control flow graph 400) in the memory device 110 and can execute the compiler 205 to generate the intraprocedure hot sections 800 (i.e., hot traces) and intraprocedure cold sections 900 (i.e., cold traces) in the memory device 110. The processor 105 can then access the intraprocedure hot sections 800 and the intraprocedure cold sections 900 in the memory device 110 and can execute the compiler 205 to generate the assembly code 230 in the memory device 110.

It is to be understood that the generation of the assembly code 230 by the compiler 205 is an optional step in the present invention. It is to be further understood that the generation of the assembly code 230 is an intermediate step to generating the directed call graph (e.g., directed call graph 1100 or 1200) in the present invention and that the directed call graph can be generated based on the control flow graphs (e.g., control flow graph 600), the intraprocedure hot sections 800 and the interprocedure cold sections 900 without generating an assembly code 230.

In step 1925, the linker 210 obtains a directed call graph (e.g., directed call graph 1100 or 1200) for the computing code 110. The directed call graph includes a control flow graph (e.g., control flow graph 600 or 1102) for each of the procedures 220 in the computing code 215. Additionally, the directed call graph includes the interprocedure edges 1105 that link the procedures 220 in the computing code 215 (e.g., link a caller node 1110 of a procedure 220 to a callee node 1115 of another procedure 220). The directed call graph (e.g., directed call graph 1100 or 1200) also includes the local block weight 405 for each code block 300, the edge procedure weight 1135 for each interprocedure edge 1105 and the root procedure weight 1125 for each root procedure 1120 in the computing code 215.

In one embodiment, the linker 210 builds a control flow graph 1102 for each procedure 220 in the computing code 100 based on the assembly code 230. The linker 210 then connects the caller nodes 1110 to the callee nodes 1115 in the control flow graphs with interprocedure edges 1105, based on the assembly code 230, to create the directed call graph (e.g., directed call graph 1100 or 1200). The linker 210 adds the local block weights 405 to the directed call graph based on the assembly code 230. Additionally, the linker 210 adds the root weights 1125 and the interprocedure edge weights 1135 to the directed call graph (e.g., directed call graph 1100 or 1200) based on the interprocedure call profile 235. Further, the linker 210 can add the hot directives and cold directives to the directed call graph based on the assembly code 230.

Also in step 1925, the linker 210 computes a global block weight 1130 for each code block 300 represented in the directed call graph (e.g., directed call graph 1100 or 1200), as is explained more fully herein. The global block weight 1130 for each code block 300 is based on the local block weights 405 of the code block 300, as is explained more fully herein.

In step 1930, the linker 210 selectively groups and intermixes the hot blocks 805 in the intraprocedure hot sections 800 (i.e., hot traces) into an interprocedure hot section 1600 and the cold blocks 905 in the intraprocedure cold sections 900 (i.e., cold traces) into an interprocedure cold section 1700, based on the global block weights 1130 of the code blocks 300, as is described more fully herein. In one embodiment, the linker 210 selectively performs interprocedure transformations on the caller nodes 1110 in the computing code 215, as is described more fully herein. The interprocedure transformation of a caller node 1110 includes replacing the argument store call segment 1320 with a register move code segment 1445 in the caller node 1110 and replacing the call code segment 1325 with a branch code segment 1450 in the caller node 1110. Additionally, the interprocedure transformation includes replicating one or more instruction code segments 1310 from the callee node 1115 and from successor code blocks 300 of the callee node 1115 into the caller node 1110 between the register move code segment 1445 and the branch code segment 1450, as is described more fully herein. In one embodiment, the linker 210 generates the interprocedure hot section 1600 and interprocedure cold section 1700, based on the hot directives and cold directives.

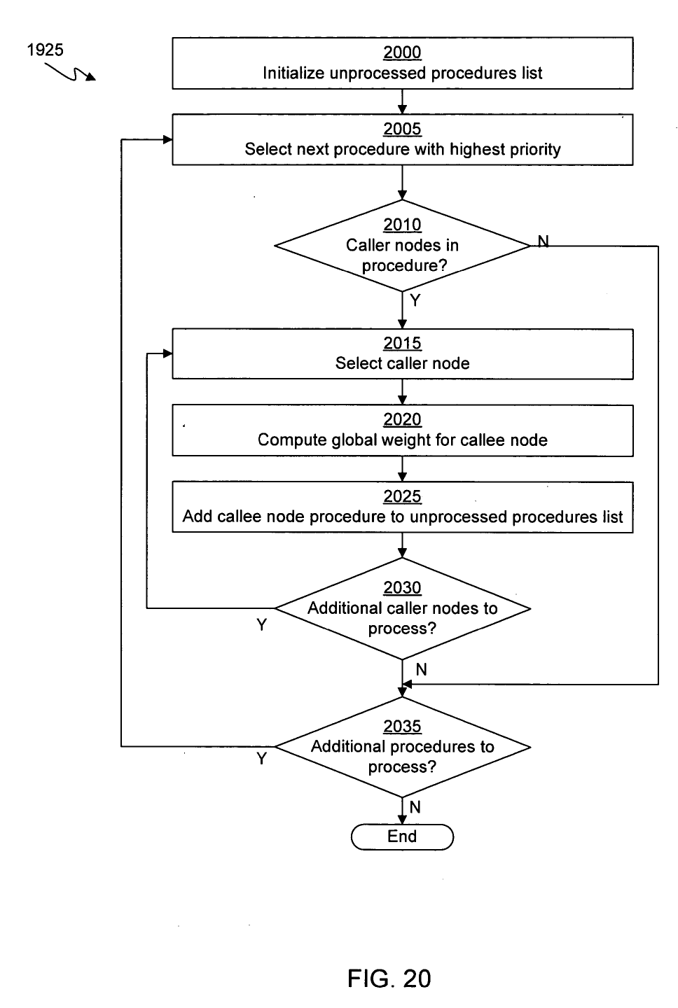

Referring now to FIG. 20, more details of the step 1925 for obtaining a directed call graph (e.g., directed call graphs 1100 or 1200) are shown. In step 2000, the linker 205 initializes an unprocessed procedures list by adding the root procedures 1120 of the computing code 215 to the unprocessed procedures list. Additionally, the linker 205 initializes the global block weight 1130 for each code block 300 in the computing code 215 to the local block weight 405 of the code block 300. Further, the linker 210 can initialize a procedure weight for each procedure 220 in the computing code 215 to the global block weight 1130 of the prologue code block 310 in the procedure 220.

In step 2005, the linker 210 uses a selection algorithm to select the unprocessed procedure 220 in the unprocessed procedures list that has the highest priority. In one embodiment, the selection algorithm selects the unprocessed procedure 220 in the unprocessed procedures list that has the highest procedure weight that is above a threshold value.

In step 2010, the linker 210 determines if there are unprocessed caller nodes 1110 in the procedure 220. If there are unprocessed caller nodes 1110 in the procedure 220, the method proceeds to step 2015, otherwise the method proceeds to step 2035.

In step 2015, the linker 210 selects an unprocessed caller node 1100 in the procedure 220. In one embodiment, the linker 210 selects the unprocessed caller node 1100 that has the highest procedure weight. In another embodiment, the linker 210 selects the unprocessed caller node 1110 based on a depth-first traversal of the directed call graph (e.g., directed call graph 1100 or 1200).

In step 2020, the linker 210 computes a new global block weight 1130 for each successor callee node 1115 of the caller node 1110 (i.e., callee nodes 1115 that are linked to the caller node 1110 with an interprocedure edge 1105). Additionally, the linker 210 computes a new global block weight 1130 for the remaining code blocks 300 in each procedure 220 containing a successor callee node 1115 based on the new global block weight 1130 of the callee node 1115. In one embodiment, the new global block weight 1130 for a callee node 1115 that has only one predecessor caller node 1110 is computed by multiplying the global block weight 1130 of the caller node 1110 times the interprocedure edge weight 1135 of the interprocedure edge 1105 linked to the predecessor caller node 1110 and callee node 1115 times the local block weight 405 of the callee node 1115. Also, in this embodiment, the new global block weight 1130 for each of the remaining code blocks 300 in the procedure 220 containing the callee node 1115 is computed by multiplying the new global block weight 1130 of the callee node 1115 times the local block weight 405 of the code block 300.

In one embodiment, for callee nodes 1115 that have multiple predecessor caller nodes 1110, the new global block weight 1130 for the callee node 1115 is computed by first computing an intermediary global block weight for each predecessor caller node 1110 by multiplying the global block weight 1130 of the predecessor caller node 1110 times the interprocedure edge weight 1135 of the interprocedure edge 1105 linked to the predecessor caller node 1110 and callee node 1115 times the local block weight 405 of the callee node 1115. The intermediary global block weights for the predecessor caller nodes 1110 are then summed to compute the global block weight 1130 of the callee node 1115.

In step 2025, the linker 210 adds the successor callee nodes 1115 of the caller node 1110 to the unprocessed procedures list.

In step 2030, the linker 210 determines if there are additional caller nodes 1110 (i.e., unprocessed caller nodes 1110) to process for the selected procedure 220. If there are additional caller nodes 1110 to process, the method returns to step 2015, otherwise the method proceeds to step 2035.

In step 2035, the linker determines if there are additional procedures 220 (i.e., unprocessed procedures 220) to process in the unprocessed procedures list. If there are unprocessed procedures 220 in the unprocessed procedures list, the method returns to step 2005, otherwise this portion of the method ends.

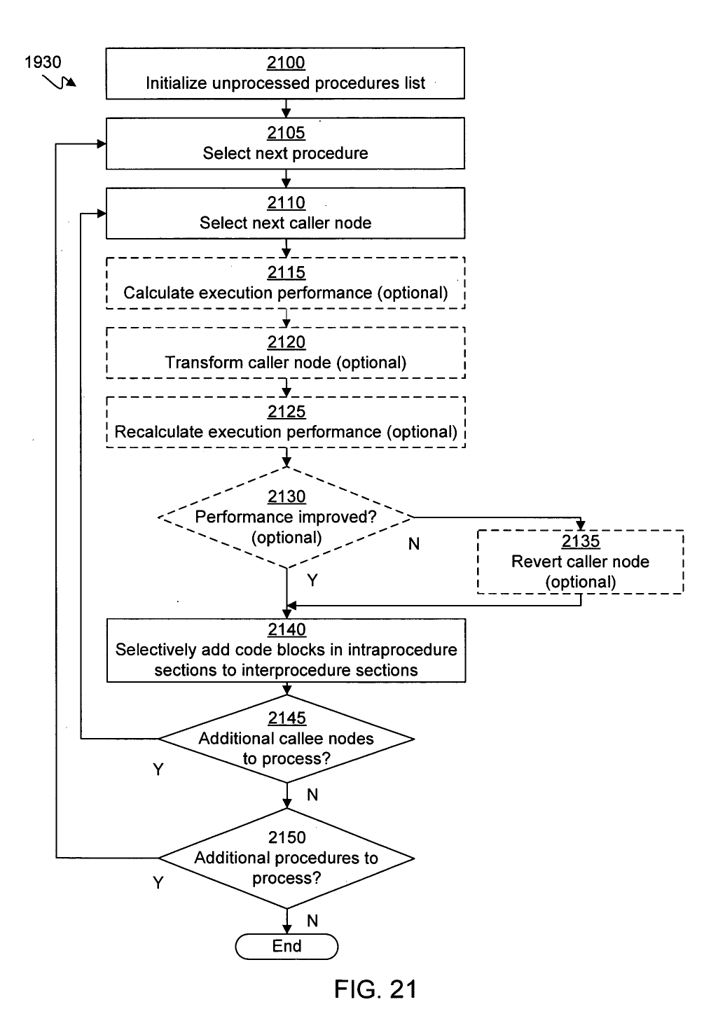

Referring now to FIG. 21, more details of the step 1930 for selectively grouping intraprocedure hot sections 800 (i.e., hot traces) into the interprocedure hot section 1600 and intraprocedure cold sections 900 (i.e., cold traces) into the interprocedure cold section 1700 is shown. In step 2100, the linker initializes an unprocessed procedures list to contain the root procedures 1120 in the computing code 215.

In step 2105, the linker 210 selects the next unprocessed procedure 220 with the highest priority in the unprocessed procedures list that has one or more caller nodes 1110 (i.e., unprocessed caller nodes 1110) to process. In one embodiment, the priority of a procedure 220 in the unprocessed procedures list is a procedure weight. In this embodiment, the linker 210 initializes a procedure weight for each procedure 220 in the unprocessed procedures list to the global block weight 1130 of the prologue code block 310 of the procedure 220. Also in this embodiment, the linker 210 selects the unprocessed procedure 220 in the unprocessed procedures list that has the highest procedure weight.

In another embodiment, the linker 210 computes a priority for each unprocessed procedure 220 in the unprocessed procedures list based on performance characteristics (e.g. statistical information or performance measurements) in the interprocedure call profile 235. In this embodiment, the linker 210 accesses the performance characteristics in the interprocedure call profile 235 and inserts the performance characteristics into the directed call graph (e.g., directed call graph 1100 or 1200) of the computing code 215. The linker 210 then accesses the performance characteristics from the directed call graph of the computing code 215. The performance characteristics accessed by the linker 210 include the number of invocations of each procedure 220 in the unprocessed procedures list and the number of computing cycles spent executing each procedure 220 during execution of the instrumented computing code 215 to create the interprocedure call profile 235. The number of computing cycles spent executing a given procedure 220 includes the computing cycles spent executing the computing instructions 305 in the procedure 220 but does not include the computing cycles spent executing other procedures 220 invoked via procedure calls made by the procedure 220.

In this embodiment, the linker 210 sums the number of invocations of all procedures 220 in the unprocessed procedures list to compute a cumulative number of procedure invocations for these procedures 220. Additionally, the linker 210 sums the number of computing cycles spent executing all of the procedures 220 in the unprocessed procedures list to compute a cumulative number of computing cycles for these procedures 220. The linker 210 also computes a cumulative product for the procedures 220 in the unprocessed procedures list by multiplying the cumulative number of procedure invocations by the cumulative number of computing cycles for these procedures 220. Further, the linker 210 computes the priority of each procedure 220 in the unprocessed procedures list by multiplying the number of invocations of the procedure 220 times the number of computing cycles spent executing the procedure 220, and dividing this product by the cumulative product of the procedures 220.

In step 2110, the linker 210 selects the next caller node 1110 for processing. In one embodiment, the order of processing the caller nodes 1110 is based on the interprocedure edge weights 1135 of the interprocedure edges 1105 linked to the unprocessed caller nodes 1110 of the selected procedure 220. For example, the linker 210 can use an algorithm to select the caller node 1115 that is linked to an interprocedure edge 1105 that has the highest interprocedure edge weight 1135. In another embodiment, the order of processing the caller nodes 1110 is based on a depth-first search algorithm. In this embodiment, the linker 210 performs a depth-first traversal of the directed call graph to select the next caller node 1110 for processing.

In step 2115, the linker 210 calculates the execution performance of the selected caller node 1110. In one embodiment, the execution performance is based on the assumption that the computing instructions 305 in the selected caller node 1110 and in the callee node 1115 to which the caller node 1110 makes a procedure call are retrieved from a memory device and placed into cache lines (e.g., instruction memory lines 1305, 1405 or 1500) of a cache memory (e.g., instruction memory 1300, 1400 or 1500). In this embodiment, the linker 210 computes the number of computing cycles for executing the selected caller node 1110 by summing the number of computing cycles for executing the computing instructions 305 in the selected caller node 1110 and the number of computing cycles for retrieving the computing instructions 305 in the selected caller node 1110 from the memory device (e.g., memory latency). Further, in this embodiment, the linker 210 computes the number of computing cycles for executing the callee node 1115 by summing the number of computing cycles for executing the computing instructions 305 in the callee node 1115 and the number of computing cycles for retrieving the computing instructions in the callee node 1115 from the memory device (e.g., memory latency). The linker 210 computes the execution performance of the selected caller node 1110 by summing the number of computing cycles for executing the selected caller node 1110 and the number of computing cycles for executing the callee node 1115. It is to be understood that step 2115 is optional in the present invention.

In step 2120, the linker transforms the caller node 1110. As part of this process, the linker 210 constructs a register move code segment 1445 to move arguments of the procedure call into a local memory (e.g., registers) for the callee node 1115. In one embodiment, the locations of the arguments in the local memory are the same locations in which the callee node 1115 would store the arguments into the local memory after executing the argument restore code segment 1330 in the callee node 1115. The linker 210 replaces the argument store code segment 1320 in the caller node 1110 with the register move code segment 1445.

Also in step 2120, as part of the transformation process, the linker 210 constructs a branch code segment 1450 to branch to a branch target computing instruction 305 in the callee node 1115, as is described more fully herein. The linker 210 replaces the call code segment 1325 in the caller node 1110 with the branch code segment 1450. Additionally, the linker 210 replicates instruction code segments 1310 (e.g., computing instructions 305) in the code blocks 300 of the successor procedure 220 and inserts the replicated instruction code segments 1310 between the register move code segment 1445 and the branch code segment 1450 in the caller node 1110 of the predecessor procedure 220. The linker 210 selects the computing instructions 305 to replicate so that the branch code segment 1450 will be located near the end of an instruction memory line (e.g., instruction memory line 1405).

In one embodiment, the linker 210 groups the computing instructions 305 in the callee node 1115 into an argument restore code segment 1330, an address restore code segment 1335 and two consecutive instructions code segments 1310. The branch target computing instruction 305 is the first computing instruction 305 in the second instruction code segment 1310. The first code segment 1310 is replicated between the register code segment 1445 and the branch code segment 1450 in the caller node 1110. The linker 210 selects the sizes of the instruction code segments 1310 by choosing the branch target computing instruction 305 so that the branch code segment 1450 will be located near the end of an instruction memory line (e.g., instruction memory line 1405a) of an instruction memory (e.g., instruction memory 1400).

If the callee node 1115 does not contain enough computing instructions 305 to locate the branch code segment 1450 near the end of the instruction memory line (e.g., instruction memory line 1405a), computing instructions 305 in a successor code block 300 of the callee node 1115 can also be replicated into the caller node 1110 essentially in the same manner as described herein. It is to be understood that step 2120 is optional in the present invention.

In step 2125, the linker 210 recalculates the execution performance of the procedure 220 containing the caller node 1110 (i.e., predecessor procedure) in essentially the same manner as is described herein for calculating the execution performance of the procedure 220 before the transformation of the procedure had occurred. It is to be understood that step 2125 is optional in the present invention.

In step 2130, the linker 210 determines if the execution performance of the procedure 220 has improved after the transformation. If the execution performance has not improved, the method proceeds to step 2135, otherwise the method proceeds to step 2140. It is to be understood that step 2130 is optional in the present invention.

In step 2135, the linker 210 reverts the caller node 1110 back into the original caller node 1110, as it existed before the transformation. The method then proceeds to step 2140. It is to be understood that step 2135 is optional in the present invention.

In step 2140, arrived at from the determination in step 2130 that the execution performance of the caller node 1110 has improved, or from step 2135 in which the linker 210 has reverted the caller node 1110 back into the original caller node 1110, the linker 210 selectively adds code blocks 300 of the caller node 1110 and the callee node 1115 to the interprocedure hot section 1600 and interprocedure cold section 1700. In this process, the linker 210 selectively adds the hot blocks 805 in the intraprocedure hot section 800 of the procedure 220 to the interprocedure hot section 1600, as is described more fully herein. In one embodiment, the linker 210 inserts one or more hot blocks 805 in the callee node 1115 of the successor procedure 220 into the interprocedure hot section 1600. In one embodiment, the linker 210 inserts the intraprocedure hot section 800 (i.e., hot trace) of the successor procedure 220 into the interprocedure hot section 1600 at a position following the caller node 1110 in the interprocedure hot section 1600. In one embodiment, the linker 210 uses the hot directives in the directed call graph (e.g., directed call graph 1100 or 1200) to add the hot blocks 805 into the interprocedure hot section 1600.

Also in step 2140, the linker 210 selectively adds the cold blocks 905 of the selected procedure 220 to the interprocedure cold section 1700. In one embodiment, the linker 210 adds the intraprocedure cold section 900 (i.e., cold trace) of the procedure 220 to the interprocedure cold section 1700. In one embodiment, the linker 210 uses the cold directives in the directed call graph (e.g., directed call graph 1100 or 1200) to add the cold blocks 905 into the interprocedure cold section 1700.

In step 2145, the linker 210 determines if there are additional caller nodes 1110 to process in the selected procedure 220. If there are no additional caller nodes 1110 to process, the method proceeds to step 2150, otherwise the method returns to step 2110.

In step 2150, the linker 210 determines if there are additional unprocessed procedures 220 to process in the unprocessed procedures list. If there are additional procedures 220 to process, the method returns to step 2105, otherwise this portion of the method ends.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for optimizing a computing code containing multiple procedures, each procedure including at least one computing instruction grouped into at least one code block, the method comprising the steps of:
I) for each procedure:
A) obtaining a local block weight for each code block in the procedure;
B) identifying each code block as a hot block or a cold block, based on the local block weight of the code block;
C) grouping the hot blocks into an intraprocedure hot section and the cold blocks into an intraprocedure cold section;
II) obtaining a global block weight for each code block in the computing code; and
III) selectively grouping the hot blocks contained in the intraprocedure hot sections into an interprocedure hot section and the cold blocks contained in the intraprocedure cold sections into an interprocedure cold section, based on the global block weights.

2. A method as recited in claim 1, wherein the local block weight of each code block in each procedure is based on a performance characteristic of the code block.

3. A method as recited in claim 1, further comprising the step of obtaining a control flow graph for each procedure, the control flow graph including the local block weights of the code blocks in the procedure.

4. A method as recited in claim 1, further comprising the steps of:
instrumenting the computing code;
executing the instrumented computing code on a set of inputs to generate an intraprocedure path profile for each procedure; and
building a control flow graph for each procedure based on the intraprocedure path profile of the procedure, the control flow graph including the local block weights of the code blocks in the procedure.

5. A method as recited in claim 4 wherein the local block weight is the execution frequency of the code block during execution of the instrumented computing code.

6. A method as recited in claim 1, further comprising the step of obtaining a directed call graph for the computing code, the directed call graph including the global block weights of the code blocks in the computing code.

7. A method as recited in claim 6, wherein some of the code blocks are caller nodes and some of the code blocks are callee nodes, the directed call graph further comprising interprocedure edges, wherein each interprocedure edge links one of the callee nodes to one of the caller nodes.

8. A method as recited in claim 7, wherein obtaining the directed call graph comprises:
instrumenting the computing code;
executing the instrumented computing code on a set of inputs to generate an interprocedure call profile; and
building the directed call graph based on the interprocedure call profile, the directed call graph including an interprocedure edge weight for each interprocedure edge in the directed call graph.

9. A method as recited in claim 8, wherein the interprocedure edge weight for each interprocedure edge is based on a performance characteristic of the caller node linked to the interprocedure edge.

10. A method as recited in claim 8, wherein building the directed call graph further comprises computing the global block weights based on the local block weights and the interprocedure edge weights.

11. A method as recited in claim 8, wherein the interprocedure edge weight is the ratio of the execution frequency of the caller node to the execution frequency of the callee node during execution of the instrumented computing code.

12. A method as recited in claim 1, wherein grouping the hot blocks into an intraprocedure hot section and the cold blocks into an intraprocedure cold section comprises selectively modifying control constructs in the procedure.

13. A method as recited in claim 1, further comprising the step of generating an executable code image for the optimized computing code.

14. A method as recited in claim 1, further comprising the step of selectively performing interprocedure transformations on the code blocks.

15. A method as recited in claim 14, wherein a first procedure has a call code segment for making a procedure call to a second procedure, and selectively performing interprocedure transformations comprises:
selecting a branch target computing instruction in the second procedure;
constructing a branch code segment for the first procedure, wherein the branch code segment includes a branch computing instruction for branching to the branch target computing instruction in the second procedure;
replacing the call code segment in the first procedure with the branch code segment; and
replicating at least one computing instruction located before the branch target computing instruction in the second procedure into the first procedure at a location before the branch code segment.

16. A method as recited in claim 15, wherein selectively performing interprocedure transformations further comprises selecting the number of computing instructions to replicate based on the size of a cache line in a cache memory to optimize the computing code for execution from the cache memory.

17. A method as recited in claim 15, wherein selectively performing interprocedure transformations further comprises selecting the number of computing instructions to replicate based on the size of a cache line in a cache memory to locate the branch code segment approximately at the end of the cache line.

18. A method as recited in claim 15, wherein the first procedure includes an argument store code segment for storing arguments for the procedure call, the second procedure includes an argument restore code segment for retrieving the arguments and storing the arguments in a local memory for the second procedure, and selectively performing interprocedure transformations further comprises:
constructing a register move code segment for the first procedure, the register move code segment including instructions for moving the arguments of the procedure call into the local memory for the second procedure; and
replacing the argument store code segment in the first procedure with the register move code segment, wherein the branch code segment branches over the argument restore code segment in the second procedure for the procedure call.

19. A computer program product for optimizing a computing code containing multiple procedures, each procedure including at least one computing instruction grouped into at least one code block, the computer program product comprising computer program code for performing the steps of:
I) for each procedure:
A) obtaining a local block weight for each code block in the procedure;
B) identifying each code block as a hot block or a cold block, based on the local block weight of the code block;
C) grouping the hot blocks into an intraprocedure hot section and the cold blocks into an intraprocedure cold section;
II) obtaining a global block weight for each code block in the computing code; and
III) selectively grouping the hot blocks contained in the intraprocedure hot sections into an interprocedure hot section and the cold blocks contained in the intraprocedure cold sections into an interprocedure cold section, based on the global block weights.

20. A computer program product as recited in claim 19 wherein the local block weight of each code block in each procedure is based on a performance characteristic of the code block.

21. A computer program product as recited in claim 19, further comprising computer program code for performing the step of obtaining a control flow graph for each procedure, the control flow graph including the local block weights of the code blocks in the procedure.

22. A computer program product as recited in claim 19, further comprising computer program code for performing the steps of:
instrumenting the computing code;
executing the instrumented computing code on a set of inputs to generate an intraprocedure path profile for each procedure; and
building a control flow graph for each procedure based on the intraprocedure path profile of the procedure, the control flow graph including the local block weights of the code blocks in the procedure.

23. A computer program product as recited in claim 22 wherein the local block weight is the execution frequency of the code block during execution of the instrumented computing code.

24. A computer program product as recited in claim 19, further comprising computer program code for performing the step of obtaining a directed call graph for the computing code, the directed call graph including the global block weights of the code blocks in the computing code.

25. A computer program product as recited in claim 24, wherein some of the code blocks are caller nodes and some of the code blocks are callee nodes, the directed call graph further comprising interprocedure edges, wherein each interprocedure edge links one of the callee nodes to one of the caller nodes.

26. A computer program product as recited in claim 25, wherein obtaining the directed call graph comprises:
instrumenting the computing code;
executing the instrumented computing code on a set of inputs to generate an interprocedure call profile for the computing code; and
building the directed call graph based on the interprocedure call profile, the directed call graph including an interprocedure edge weight for each interprocedure edge in the directed call graph.

27. A computer program product as recited in claim 26, wherein building the directed call graph further comprises computing the global block weights based on the local block weights and the interprocedure edge weights.

28. A computer program product as recited in claim 26, wherein the interprocedure edge weight for each interprocedure edge is based on a performance characteristic of the caller node linked to the interprocedure edge.

29. A computer program product as recited in claim 27, wherein the interprocedure edge weight is the ratio of the execution frequency of the caller node to the execution frequency of the callee node during execution of the instrumented computing code.

30. A computer program product as recited in claim 19 wherein grouping the hot blocks into an intraprocedure hot section and the cold blocks into an intraprocedure cold section further comprises selectively modifying control constructs in the procedure.

31. A computer program product as recited in claim 19, further comprising computer program code for performing the step of generating an executable code image for the optimized computing code.

32. A computer program product as recited in claim 19, further comprising computer program code for performing the step of selectively performing interprocedure transformations on the code blocks.

33. The computer program product as recited in claim 32, wherein a first procedure has a call code segment for making a procedure call to a second procedure, and selectively performing interprocedure transformations comprises:
selecting a branch target computing instruction in the second procedure;
constructing a branch code segment for the first procedure, the branch code segment including a branch computing instruction for branching to the branch target computing instruction in the second procedure;
replacing the call code segment in the first procedure with the branch code segment; and
replicating at least one computing instruction located before the branch target computing instruction in the second procedure into the first procedure at a location before the branch code segment.

34. A computer program product as recited in claim 33, wherein selectively performing interprocedure transformations further comprises selecting the number of computing instructions to replicate based on the size of a cache line in a cache memory to optimize the computing code for execution from the cache memory.

35. A computer program product as recited in claim 33, wherein selectively performing interprocedure transformations further comprises selecting the number of computing instructions to replicate based on the size of a cache line in a cache memory to locate the branch code segment approximately at the end of the cache line.

36. A computer program product as recited in claim 33, wherein the first procedure includes an argument store code segment for storing arguments for the procedure call and the second procedure includes an argument restore code segment for retrieving the arguments and storing the arguments in a local memory for the second procedure, and selectively performing interprocedure transformations further comprises:
constructing a register move code segment for the first procedure, wherein the register move code segment includes instructions for moving the arguments of the procedure call into the local memory for the second procedure; and
replacing the argument store code segment in the first procedure with the register move code segment, wherein the branch code segment branches over the argument restore code segment in the second procedure for the procedure call.

37. A system for optimizing a computing code containing multiple procedures, each procedure including at least one computing instruction grouped into at least one code block, the system comprising:
a compiler configured to obtain a local block weight for each code block in the procedure, identify each code block as a hot block or a cold block based on the local block weight of the code block, and group the hot blocks into an intraprocedure hot section and the cold blocks into an intraprocedure cold section; and
a linker configured to obtain a global block weight for each code block in the computing code, and to selectively group the hot blocks contained in the intraprocedure hot sections into an interprocedure hot section and the cold blocks contained in the intraprocedure cold sections into an interprocedure cold section.

38. A system as recited in claim 37, wherein the compiler is further configured to obtain a control flow graph for each procedure, the control flow graph including the local block weights of the code blocks in the procedure.

39. A system as recited in claim 37, wherein the compiler is further configured to generate an assembly code including directives for the intraprocedure hot sections and the intraprocedure cold sections.

40. A system as recited in claim 37, wherein the linker is further configured to generate an executable code image based on the code blocks in the interprocedure hot section and the code blocks in the interprocedure cold section.

41. A system as recited in claim 37, wherein the compiler is further configured to instrument the computing code, generate an intraprocedure path profile for each procedure based on the instrumented computing code, and build a control flow graph for each procedure based on the intraprocedure path profile of the procedure, the control flow graph including the local block weights of the code blocks in the procedure.

42. A system as recited in claim 37, wherein the linker is further configured to obtain a directed call graph for the computing code, the directed call graph including the global block weights of the code blocks in the computing code.

43. A system as recited in claim 42, wherein some of the code blocks are caller nodes and some of the code blocks are callee nodes, the directed call graph further comprising interprocedure edges, wherein each interprocedure edge links one of the callee nodes to one of the caller nodes.

44. A system as recited in claim 43, wherein the linker is further configured to obtain the directed call graph by instrumenting the computing code, generating an interprocedure call profile based on the instrumented computing code, and building the directed call graph based on the interprocedure call profile, the directed call graph including an interprocedure edge weight for each interprocedure edge, wherein the global block weights are based on the local block weights and the interprocedure edge weights.

45. A method for optimizing a computing code containing multiple procedures, each procedure including at least one computing instruction grouped into at least one code block, the method comprising:
step-means for obtaining a local block weight for each code block in each procedure;
step-means for identifying each code block as a hot block or a cold block based on the local block weight of the code block;
step-means for grouping the hot blocks of each procedure into an intraprocedure hot section for the procedure and for grouping the cold blocks of the procedure into an intraprocedure cold section for the procedure;
step-means for obtaining a global block weight for each code block in the computing code; and
step-means for selectively grouping the hot blocks contained in the intraprocedure hot sections into an interprocedure hot section based on the global block weights and for grouping the cold blocks contained in the intraprocedure cold sections into an interprocedure cold section based on the global block weights.

46. A system for optimizing a computing code containing multiple procedures, each procedure including at least one computing instruction grouped into at least one code block, the system comprising:
means for identifying each code block as a hot block or a cold block, based on a local block weight of the code block, and for grouping the hot blocks in each procedure into an intraprocedure hot section for the procedure and the cold blocks in each procedure into an intraprocedure cold section for the procedure;
means for obtaining a global block weight for each code block in the computing code and for selectively grouping the hot blocks in the intraprocedure hot sections into an interprocedure hot section and the cold blocks in the intraprocedure cold sections into an interprocedure cold section.

47. A computing system for optimizing a computing code containing multiple procedures, each procedure including at least one computing instruction grouped into at least one code block, the computing system comprising:
a compiler;
a linker;
a memory device;
an input-output device; and
a processor configured to load the computing code and the compiler from the input-output device into the memory device and to execute the compiler to obtain a local block weight for each code block, identify each code block as a hot block or a cold block based on the local block weight of the code block, and group the hot blocks in each procedure into an intraprocedure hot section for the procedure and the cold blocks in each procedure into an intraprocedure cold section for the procedure, the processor further configured to load the linker from the input-output device into the memory device and to execute the linker to obtain a global block weight for each code block, and to selectively group the hot blocks in the intraprocedure hot sections into an interprocedure hot section and the cold blocks in the intraprocedure cold sections into an interprocedure cold section, based on the global block weights.

48. A computing system as recited in claim 47, wherein the processor is further configured to execute the compiler to instrument the computing code, load a set of inputs from the input-output device into the memory device, execute the instrumented computing code on the set of inputs to generate an intraprocedure path profile for each procedure, and build a control flow graph for each procedure based on the intraprocedure path profile of the procedure, the control flow graph including the local block weights.

49. A computing system as recited in claim 47, wherein the processor is further configured to execute the linker to instrument the computing code, load a set of inputs from the input-output device into the memory device, execute the instrumented computing code on the set of inputs to generate an interprocedure call profile for the computing code, and build a directed call graph for the computing code based on the interprocedure call profile, the directed call graph including the global block weights.

50. A computing system as recited in claim 47, wherein the processor is further configured to execute the linker to obtain a directed call graph for the computing code, the directed call graph including the global block weights of the code blocks in the computing code.

51. A computing system as recited in claim 50, wherein some the code blocks are caller nodes and some of the code blocks are callee nodes, the directed call graph further comprising interprocedure edges, wherein each interprocedure edge links one of the callee nodes to one of the caller nodes, the directed call graph including an interprocedure edge weight for each interprocedure edge.

52. A computing system as recited in claim 51, wherein the global block weights are based on the local blocks weights and the interprocedure edge weights.

53. A computing system as recited in claim 47, wherein the processor is further configured to execute the linker to generate an executable code image for the optimized computing code.

54. A computing system as recited in claim 47, wherein selectively grouping the hot blocks into an intraprocedure hot section and the cold blocks into an intraprocedure cold section comprises selectively modifying control constructs in the procedure.

55. A computing system as recited in claim 47, wherein the processor is further configured to execute the linker to selectively perform interprocedure transformations on the code blocks.
